(19) United States
(12) Patent Application Publication
(10) Pub. No.: US 2026/0277766 A1
(43) Pub. Date: Sep. 17, 2026

(54) ADAPTIVE VISUALIZATION OF DIGITAL ARTIFACTS

(71) Applicant: Infosys Limited, Bangalore (IN)

(72) Inventors: Rajeshwari Ganesan, Bellevue, WA (US); Debrup Dey, Bengaluru (IN); Shubham Aggarwal, London (GB); Akshatha Miyal Kamath, Bengaluru (IN)

(73) Assignee: Infosys Limited, Bangalore (IN)

(21) Appl. No.: 19/369,995

(22) Filed: Oct. 27, 2025

Related U.S. Application Data
(60) Provisional application No. 63/771,444, filed on Mar. 13, 2025.

(51) Int. Cl. G06F 11/34; G06F 3/0481; G06F 21/62

(52) U.S. Cl. CPC G06F 11/3438; G06F 3/0481; G06F 21/6209; G06F 2221/2141

(57) ABSTRACT

A system for adaptive visualization of a set of digital artifacts associated with a software product is provided. The system includes a storage element that stores the set of digital artifacts and processing circuitry associated therewith. The processing circuitry accesses a set of role attributes corresponding to an entity associated with the set of digital artifacts. The processing circuitry identifies a subset of digital artifacts from the set of digital artifacts based on the set of role attributes. The processing circuitry determines a set of user actions associated with the entity via a user device associated with the system. The processing circuitry generates a set of weights for the subset of digital artifacts based on the set of user actions. The processing circuitry selects a first digital artifact from the subset of digital artifacts based on the set of weights and renders the first digital artifact via the user device.

### CROSS-REFERENCE TO RELATED APPLICATIONS

The present application is related to and claims priority to U.S. Patent Application Ser. No. 63/771,444, filed on Mar. 13, 2025 and entitled “LEGACY CODE MODERNIZATION”, the contents of which are incorporated herein by reference.

### FIELD OF THE DISCLOSURE

Various embodiments of the present disclosure relate generally to visualization of digital artifacts. More specifically, various embodiments of the present disclosure relate to adaptive and dynamic visualization of digital artifacts associated with a software product using artificial intelligence.

### BACKGROUND

Software products (for example, modern software products and legacy software products) are typically composed of a multitude of digital artifacts, such as source code modules, configuration files, test scripts, documentation, and deployment packages. These digital artifacts are generated and maintained throughout the lifecycle of the software product by various stakeholders, including developers, project managers, quality assurance engineers, end users, or the like. Each stakeholder interacts with only a subset of these digital artifacts depending on their role and responsibilities. For example, a developer may focus on specific code modules and test scripts, whereas a project manager may be more interested in progress dashboards, release notes, and resource allocation documents.

The relevance of a given digital artifact to a user is not static. It may evolve over time based on changes in the user’s role, project phase, organizational priorities, or the like. For instance, when a developer is promoted to a project manager position, digital artifacts most pertinent to that individual shift from code-level assets to managerial or oversight-level digital artifacts. In such dynamic environments, identification, organization, and visualization of relevant digital artifacts for each user becomes technically challenging, as it requires continuous assessment of dependencies, metadata, and evolving system states in near real time.

Conventional techniques for providing visualization of relevant digital artifacts often rely on static mappings or rule-based approaches. A common implementation involves pre-selecting and periodically updating the modules or digital artifacts deemed relevant for each stakeholder, user, or role. Updates may be performed by administrators or through configuration scripts. However, conventional techniques suffer from significant drawbacks, such as a lack of adaptability to rapidly changing environments, introducing latency in reflecting evolving dependencies, and struggling to handle the scale and complexity of interrelated artifacts across heterogeneous systems. Human involvement in maintaining the static mappings further adds operational overhead and risk of inconsistency. Collectively, the above-mentioned limitations impede access to relevant artifacts, slow down decision-making, and reduce the overall responsiveness of the software development and management process.

In light of the foregoing, there exists a need for a technical and reliable solution that overcomes the aforementioned limitations.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for adaptive visualization of digital artifacts are provided substantially as shown in, and described in connection with, at least one of the figures.

In an embodiment of the present disclosure, a system, which is an adaptive visualization system, is disclosed. The adaptive visualization system includes a storage element and a processing circuitry coupled thereto. The storage element is configured to store a set of digital artifacts. The processing circuitry is configured to access a first set of role attributes corresponding to a first entity associated with the set of digital artifacts. The first set of role attributes is indicative of at least one of: one or more operational constraints or one or more functional constraints associated with the first entity. The processing circuitry is further configured to identify, based on the first set of role attributes, a first subset of digital artifacts from the set of digital artifacts. The first subset of digital artifacts is contextually associated with the first set of role attributes. The processing circuitry is further configured to determine a first set of user actions associated with the first entity via a first user device associated with the system. The processing circuitry is further configured to generate, based on the first set of user actions, a first set of weights for the first subset of digital artifacts. The first set of weights is indicative of a priority associated with the first subset of digital artifacts for the first entity. The processing circuitry is further configured to select at least a first digital artifact from the first subset of digital artifacts based on the first set of weights. The processing circuitry is further configured to render, via a first visualization interface of the first user device, the selected at least the first digital artifact.

In some embodiments, the processing circuitry is configured to select a second digital artifact from the first subset of digital artifacts based on the first set of weights. The processing circuitry is further configured to render, via the first visualization interface of the first user device, the selected second digital artifact.

In some embodiments, the first set of user actions is determined for a predefined time interval.

In some embodiments, the processing circuitry is configured to determine a second set of role attributes corresponding to a second entity associated with the set of digital artifacts. The second set of role attributes is indicative of at least one of: one or more operational constraints or one or more functional constraints associated with the second entity. The processing circuitry is further configured to identify, based on the second set of role attributes, a second subset of digital artifacts from the set of digital artifacts. The second subset of digital artifacts is contextually associated with the second set of role attributes. The processing circuitry is further configured to determine a second set of user actions associated with the second entity via a second user device associated with the system. The second set of user actions is determined for the predefined time period. The processing circuitry is further configured to generate, based on the second set of user actions, a second set of weights for the second subset of digital artifacts. The second set of weights is indicative of a priority associated with the second subset of digital artifacts for the second entity. The processing circuitry is further configured to select at least a third digital artifact from the second subset of digital artifacts based on the second set of weights. The processing circuitry is further configured to render, via a second visualization interface of the second user device, at least the third digital artifact.

In some embodiments, the storage element is further configured to store a set of belief spaces associated with the set of digital artifacts. Each belief space of the set of belief spaces includes a set of belief types associated with a corresponding digital artifact of the set of digital artifacts. The processing circuitry is further configured to identify, based on the selected at least the first digital artifact, a first belief space of the set of belief spaces associated with the first digital artifact. The processing circuitry is further configured to determine, based on the first set of user actions, a subset of belief types from a first set of belief types associated with the first belief space. The processing circuitry is further configured to render, via the first visualization interface, the subset of belief types and a set of belief states associated with the subset of belief types.

In some embodiments, the storage element is further configured to store at least one of: a user interaction agent, an event processing agent, a visualization agent, a reinforcement learning agent, or a dependency analysis agent.

In some embodiments, the processing circuitry is further configured to utilize the user interaction agent for the determination of the first set of user actions. To determine the first set of user actions, the user interaction agent is configured to monitor the first visualization interface of the first user device. The user interaction agent is further configured to record, based on the monitoring, the first set of user actions via the first visualization interface of the first user device.

In some embodiments, the processing circuitry is further configured to utilize the visualization agent for the selection of at least the first digital artifact. The visualization agent is configured to receive the first set of user actions from the user interaction agent. The visualization agent is further configured to determine a set of prioritization criteria associated with the first entity based on at least one of: the first set of role attributes or the first set of user actions. The set of prioritization criteria is indicative of the priority associated with the first subset of digital artifacts for the first entity. The visualization agent is further configured to generate the first set of weights based on the set of prioritization criteria.

In some embodiments, the set of prioritization criteria is determined further based on an analytic hierarchy process (AHP).

In some embodiments, the visualization agent is configured to determine a context associated with the first set of user actions. The visualization agent is further configured to generate, based on the context, a set of user feedback associated with the first entity. The visualization agent is further configured to re-generate the first set of weights for the first subset of digital artifacts based on the set of user feedback. The visualization agent is further configured to select at least a fourth digital artifact of the first subset of digital artifacts based on the re-generated first set of weights. The visualization agent is further configured to render, via the first visualization interface of the first user device, the selected at least the fourth digital artifact.

In some embodiments, the storage element is further configured to store a set of logic constraints that includes a subset of logic constraints that pertains to the priority associated with the first subset of digital artifacts for the first entity. The processing circuitry is further configured to update the subset of logic constraints based on the set of user feedback.

In some embodiments, the processing circuitry is further configured to utilize the visualization agent for the selection of at least the first digital artifact. The storage element is further configured to store a set of logic constraints that includes a first subset of constraints that pertains to the priority associated with the first subset of digital artifacts for the first entity. The visualization agent is configured to generate the first set of weights based on the first subset of logic constraints of the set of logic constraints. The visualization agent is further configured to identify at least the first digital artifact from the first subset of digital artifacts based on the first set of weights.

In some embodiments, the processing circuitry is further configured to utilize the event processing agent to detect a first event associated with at least the first digital artifact. At least the first digital artifact is associated with at least a fourth digital artifact of the first subset of digital artifacts. The processing circuitry is further configured to select at least the fourth digital artifact based on the detection of the first event. The visualization agent is configured to render, based on the first event, at least the first digital artifact in association with at least the fourth digital artifact via the first visualization interface.

In some embodiments, the processing circuitry is further configured to utilize the dependency analysis agent to determine the association between at least the first digital artifact and at least the fourth digital artifact. The dependency analysis agent is configured to determine the association between at least the first digital artifact and at least the fourth digital artifact based on at least one of: the first set of role attributes or a dependency graph associated with the set of digital artifacts.

In some embodiments, the association between at least the first digital artifact and at least the fourth digital artifact is one of a semantic association or a syntactic association.

In some embodiments, the storage element includes at least one of: a long-term memory or a short-term memory. The processing circuitry is further configured to retrieve the first set of role attributes corresponding to the first entity associated with the set of digital artifacts from the long-term memory. The processing circuitry is further configured to store the first set of user actions in the short-term memory. The reinforcement learning agent is configured to access the first set of user actions stored in the short-term memory. The reinforcement learning agent is further configured to determine a set of feedback based on the first set of user actions. The reinforcement learning agent is further configured to update a set of logic constraints associated with the set of digital artifacts based on the set of feedback.

In some embodiments, the processing circuitry is further configured to receive a user query via the first visualization interface of the first user device associated with the first entity. The user interaction agent is further configured to determine a context of the user query based on a set of tokens associated with the user query. The user interaction agent is further configured to identify a third subset of digital artifacts of the set of digital artifacts based on at least one of: the context of the user query or the first set of role attributes. The user interaction agent is further configured to generate a weighted arrangement of the third subset of digital artifacts based on a second subset of logic constraints of a set of logic constraints in the storage element. The second subset of logic constraints pertains to the priority associated with the first subset of digital artifacts for the first entity. The user interaction agent is further configured to render, via the first visualization interface of the first user device, one or more digital artifacts of the third subset of digital artifacts based on the weighted arrangement of the third subset of digital artifacts. The one or more digital artifacts are rendered in response to the user query.

In some embodiments, a computer-implemented method is disclosed. The computer-implemented method includes accessing a first set of role attributes corresponding to a first entity associated with a set of digital artifacts stored in a storage element. The first set of role attributes is indicative of at least one of: one or more operational constraints or one or more functional constraints associated with the first entity. The computer-implemented method further includes identifying, based on the first set of role attributes, a first subset of digital artifacts from the set of digital artifacts. The first subset of digital artifacts is contextually associated with the first set of role attributes. The computer-implemented method further includes determining a first set of user actions associated with the first entity via a first user device. The computer-implemented method further includes generating, based on the first set of user actions, a first set of weights for the first subset of digital artifacts. The first set of weights is indicative of a priority associated with each of the first subset of digital artifacts for the first entity. The computer-implemented method further includes selecting at least a first digital artifact from the first subset of digital artifacts based on the first set of weights. The computer-implemented method further includes rendering, via a first visualization interface of the first user device, at least the first digital artifact.

In some embodiments, a computer-readable medium is disclosed. The computer-readable medium includes instructions that, when executed by processing circuitry of a computing system, cause the computing system to perform a method for adaptive visualization of a set of digital artifacts. The method includes accessing a first set of role attributes corresponding to a first entity associated with the set of digital artifacts stored in a storage element. The first set of role attributes is indicative of at least one of: one or more operational constraints or one or more functional constraints associated with the first entity. The method further includes identifying, based on the first set of role attributes, a first subset of digital artifacts from the set of digital artifacts. The first subset of digital artifacts is contextually associated with the first set of role attributes. The method includes determining a first set of user actions associated with the first entity via a first user device. The method includes generating, based on the first set of user actions, a first set of weights for the first subset of digital artifacts. The first set of weights is indicative of a priority associated with each of the first subset of digital artifacts for the first entity. The method includes selecting at least a first digital artifact from the first subset of digital artifacts based on the first set of weights. The method includes rendering, via a first visualization interface of the first user device, at least the first digital artifact.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates a system environment of an adaptive visualization system, consistent with embodiments of the present disclosure;

FIG. 2 is a block diagram that illustrates the adaptive visualization system of the system environment of FIG. 1, consistent with disclosed embodiments of the present disclosure;

FIG. 3 illustrates a schematic diagram depicting an exemplary interface of a user application associated with the adaptive visualization system, consistent with disclosed embodiments of the present disclosure;

FIG. 4 illustrates a schematic diagram of another exemplary interface of the user application associated with the adaptive visualization system, consistent with disclosed embodiments of the present disclosure;

FIG. 5 shows an example computing system for carrying out the methods of the present disclosure, consistent with disclosed embodiments of the present disclosure; and

FIG. 6 is a flowchart that illustrates a method for adaptive visualization of digital artifacts, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Generally, software products consist of multiple digital artifacts, including source code modules, configuration files, test scripts, documentation, deployment packages, or the like. These digital artifacts may be created and updated throughout the product lifecycle by different stakeholders such as developers, project managers, quality engineers, end users, or the like. Notably, each stakeholder may work on a portion of these digital artifacts that may be relevant to them based on their role, access permissions, assigned task, or the like. For example, developers may focus on code and tests, while project managers may concentrate on dashboards, release notes, and resource planning documents.

Therefore, the relevance of digital artifacts for a stakeholder may be dynamic and may change with shifts in role, project stage, or organizational priorities. For instance, when a developer becomes a project manager, the relevance may change from technical code assets to managerial and oversight-related digital artifacts. In such dynamic settings, swift identification and visualization of relevant artifacts for each stakeholder may be of importance to maintain productivity and cognitive load of the stakeholder.

Conventional visualization systems for the visualization of digital artifacts depend heavily on manual effort and static configurations. A common practice involves administrators, or team leads pre-selecting and periodically updating relevant artifacts for each stakeholder through manual processes. The conventional visualization systems require explicit invocation for updates. The processing architectures of the conventional visualization systems are configured with fixed selection criteria, with manual reconfiguration.

Conventional techniques for providing visualization of digital artifacts depend on manual selection of relevant digital artifacts performed by the stakeholders, and updates may occur based on explicit invocation. Such dependency introduces computational inefficiencies and delays in reflecting changes in the relevant digital artifacts to the stakeholders. Such static configurations processing approaches for selection of relevant digital artifacts may require significant computational overhead for batch updates and lack real-time responsiveness. As a result, the stakeholders may often continue to view outdated or irrelevant artifacts, which may reduce system responsiveness and increase the risk of errors. The requirement of manual selection may create scalability limitations when presented with large numbers of stakeholders and/or digital artifacts.

The disclosed invention overcomes the above-mentioned technical drawbacks by implementing an adaptive visualization system. The adaptive visualization system may create an adaptive visualization of digital artifacts for each stakeholder. The adaptive visualization system may include a storage element having a set of digital artifacts (for example, code modules, documents, media files, or the like) associated with a software product. The set of digital artifacts may be associated with a plurality of entities (for example, developers, end-users, project managers, or the like) that may be various stakeholders associated with the software product. The adaptive visualization system may include processing circuitry that may be configured to automatically access role attributes corresponding to each entity associated with the set of digital artifacts. The role attributes may be indicative of operational constraints or functional constraints associated with the entity. The processing circuitry may be further configured to identify, based on the role attributes of the entity, a contextually relevant subset of digital artifacts and generate a weight for each digital artifact of the subset of digital artifacts based on user actions, eliminating the computational overhead of manual selection processes. The weight of each digital artifact of the subset of digital artifact may be indicative of a priority of the entity for the digital artifact. Beneficially, the disclosed system provides real-time weight generation and digital artifact prioritization without requiring system downtime or batch processing cycles.

The disclosed system addresses the technical issues of delayed visualization interface updates, computational inefficiencies in manual selection, and scalability limitations through automated processing mechanisms. The processing circuitry implements role-aware artifact identification that scales efficiently to large numbers of users and artifacts while applying consistent and customized logic constraints across all entities. The system automatically tracks user interactions through specialized agents (for example, user interaction agents) to enhance prioritization logic and provide computational auditability. The automated processing reduces training and onboarding computational requirements for new or transitioning entities by eliminating the need for manual artifact configuration knowledge.

The disclosed system achieves unified and adaptive visualization through the processing circuitry configured to coordinate multiple specialized agents, including user interaction agents, event processing agents, visualization agents, reinforcement learning agents, and dependency analysis agents. An adaptive orchestration of these agents may reduce processing time and computational effort while ensuring user-specific adaptability for the visualization of the digital artifacts. The disclosed system continuously coordinates multiple analyses through dependency analysis agents and determines correlations between digital artifacts to generate coherent representations without manual intervention.

The adaptive visualization of the digital artifacts may be achieved by multiple agents working together while being utilized by the processing circuitry. The processing circuitry may utilize a user interaction agent configured to monitor user interfaces of user devices and record user actions via the user interfaces. The user interaction agent collects a set of feedback, including explicit feedback received directly from the stakeholders and implicit feedback tracked through user interaction patterns with digital artifacts. The processing circuitry utilizes reinforcement learning to implement one or more machine learning algorithms to perform pattern analysis and extract implicit feedback based on how users (namely, entities) interact with the digital artifacts. The reinforcement learning agent may identify one or more negative interaction patterns, such as repeated query reformulations, signal dissatisfaction, and accordingly adjust logic constraints stored in the storage element to minimize conflicts and contradictions in responses. The reinforcement learning agent may identify one or more positive interaction patterns, indicated by behaviors such as extended content exploration or increased system interaction, and reinforce effective system behaviors through weight adjustments. The positive interaction patterns may reinforce the logic constraints that may be used for priority determination for the subset of digital artifacts. The adaptive visualization of the digital artifacts may be performed based on the logic constraints, which may be updated by the reinforcement learning agent in accordance with the user interaction patterns. The visualization agent may render an updated visualization interface based on the updated logic constraints, ensuring contextual relevance through automated feedback processing rather than manual configuration.

In an example, an appearance of the visualization interface adapts through the user interaction agent that is configured to monitor user interactions with rendered visualization interfaces displaying the digital artifacts. The interactions include behaviors such as repeated query reformulations, extended content exploration, or increased system engagement. The reinforcement learning agent processes these interactions to generate updated weights and adjust visual representations over time. Subsequently, in an example, the visualization agent may increase edge thickness between associated digital artifacts or modify node display characteristics based on updated priority weights. These visualization interface changes result from automated weight updates and logic constraint modifications rather than manual interface adjustments.

The processing circuitry accesses different role attributes for different entities (developers, security experts, managers, or the like), generating distinct weights for different digital artifacts for each entity based on corresponding role-specific interaction patterns. The adaptive visualization of the digital artifacts may occur independently for different user roles based on role-specific logic constraints. The disclosed system overcomes prior art limitations by maintaining automated role-based visualization profiles through implementation of the logic store and the agents rather than manual profile management.

In some embodiments, user interactions with the digital artifacts and events associated with one or more digital artifacts are detected by the event processing agents. Dependency analysis agents may determine dependency relationships between the digital artifacts based on role attributes or dependency graphs, enabling the processing circuitry to identify semantic associations or syntactic associations between the digital artifacts. In an example, an event processing agent may detect a display event associated with a first digital artifact and may trigger selection of related digital artifacts, which the visualization agent renders in association with the first digital artifact.

In some embodiments, the disclosed system provides automated query resolution through the processing circuitry configured to receive a user query via the visualization interface associated with an entity. The user interaction agent may receive the user query and determine a context of the user query based on a set of tokens associated with the user query. The visualization agent may identify relevant digital artifacts based on the context of the user query and role attributes associated with the entity. The visualization agent may further generate a weighted arrangement of the identified relevant digital artifacts based on relevant logic constraints. The visualization agent may render one or more digital artifacts from the weighted arrangement of the digital artifacts via the visualization interface. The visualization agent may identify and retrieve the relevant digital artifacts based on execution of a retrieval process that may utilize Retrieval Augmented Generation (RAG) techniques and Analytic Hierarchy Process (AHP), hence, eliminating manual query processing requirements. The retrieval process implementing the AHP may include obtaining weights from a logic store, which includes the logic constraints and performing automated prioritization, providing either highest-ranked explanations or multiple ranked explanations without manual intervention. The processing circuitry may utilize the visualization agent to formulate responses to user queries automatically while using a large language model (LLM). In cases where conflicting explanations arise, resolution is achieved through automated consensus mechanisms implemented by the processing circuitry, ensuring consistent and reliable query responses.

In some embodiments, the storage element may include a long-term memory configured to store learned information, for example, role attributes, user preferences, or the like and a short-term memory configured to store temporary information, for example, information associated with an ongoing event, one or more ongoing user actions. Hence, the storage element exhibits a dual memory architecture which enables efficient retention, persistence, identification, retrieval, and processing of data. In an example, the processing circuitry may retrieve role attributes from the long-term memory and store user actions in the short-term memory. The reinforcement learning agent may access the user actions stored in the short-term memory and determine feedback based on these actions, and update the logic constraints in the logic store. The dual memory architecture provides scalable processing capabilities and reduces computational latency compared to single-memory approaches in prior art systems, while supporting continuous learning and adaptation across multiple entities and corresponding digital artifact subsets.

### Figure description:

With advancements in the technological domains, software-based products have become indispensable to the day-to-day tasks of individuals. A software-based product may be complex in nature and may include multiple code modules forming a set of digital artifacts. Additionally, the software-based product may be associated with a plurality of entities, including, but not limited to, end users, developers, and product managers. Each entity of the plurality of entities may have a corresponding subset of digital artifacts of the set of digital artifacts that may be relevant to it. Traditionally, selection of the relevant digital artifacts may be performed manually and remains static unless updated explicitly, which is undesirable and inconvenient.

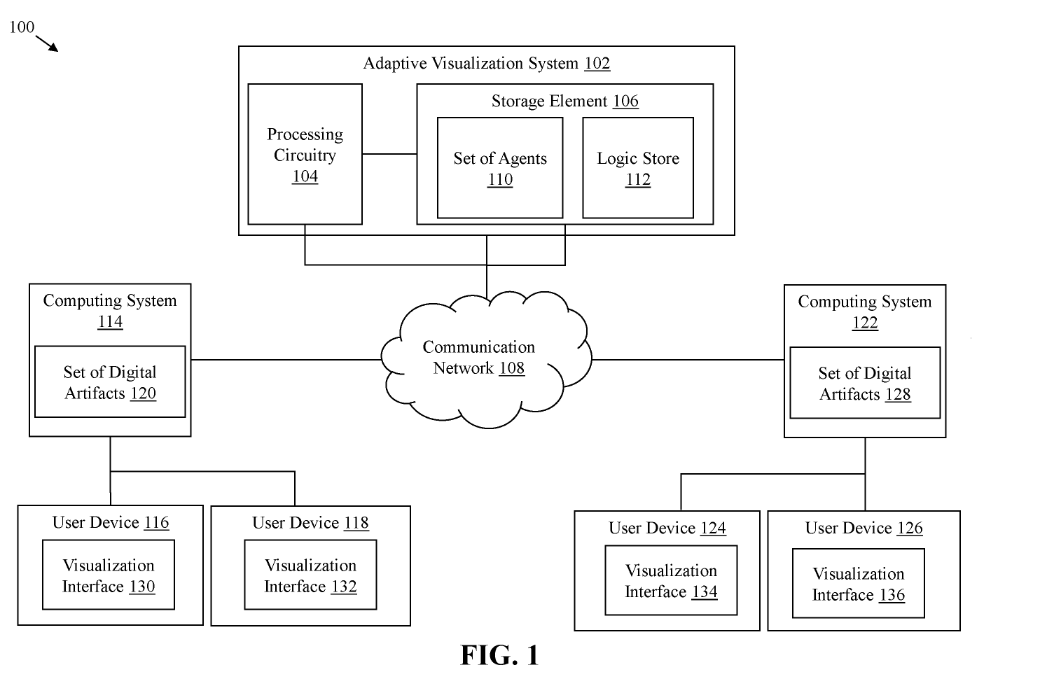

FIG. 1 is a schematic diagram that illustrates a system environment 100 of an adaptive visualization system 102, consistent with embodiments of the present disclosure. The adaptive visualization system 102 provides for dynamic and adaptive visualization of a set of digital artifacts to entities associated with a software product. The term ‘adaptive visualization system 102’ is interchangeably referred to as the ‘system 102’.

Referring to FIG. 1, the system environment 100 is shown to include the adaptive visualization system 102 having processing circuitry 104 and a storage element 106 communicatively coupled to the processing circuitry 104. In an embodiment, the processing circuitry 104 and the storage element 106 may be coupled via a communication bus (not shown).

In some embodiments, the adaptive visualization system 102 may correspond to a distributed system. In such embodiments, the processing circuitry 104 and the storage element 106 may be implemented in a distributed environment. In some embodiments, the storage element 106 may be implemented as a cloud-based storage.

In some embodiments, the processing circuitry 104 and the storage element 106 may be communicably coupled via a communication network 108. The communication network 108 may act as a medium or communication channel between two or more components of the system environment 100. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, or a combination thereof.

The processing circuitry 104 may include suitable logic, circuitry, interfaces, and/or code, that when executed, may execute one or more operations associated with an artificial intelligence (AI)-based adaptive visualization of the set of digital artifacts (for example, a set of code modules associated with a software product, where the software product may correspond to a legacy software product or a modern software product). The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person skilled in the art that the processing circuitry 104 may be compatible with multiple operating systems. The processing circuitry 104 may further include one or more components (for example, a parser, a loader, or the like) that may be configured to execute one or more operations to be executed by the processing circuitry 104. In some embodiments, the processing circuitry 104 may be a single unit. Alternatively, in some embodiments, the processing circuitry 104 may be a combination of various modules configured to execute the one or more operations associated with the AI-based adaptive visualization of the set of digital artifacts.

The storage element 106 may refer to a hardware or software component configured to store, but not limited to, a set of agents 110 and a logic store 112. The set of agents 110 and the logic store 112 in the storage element 106 may be accessed by the processing circuitry 104 for performing the AI-based adaptive visualization of the set of digital artifacts. In an embodiment, the storage element 106 may further store one or more sets of digital artifacts associated with one or more additional software products that are to be visualized. The storage element 106 may include a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.), or any combination thereof. The storage element 106 may be locally or remotely associated with the processing circuitry 104.

The set of agents 110 may correspond to one or more AI agents (for example, generative AI agents or agentic AI agents) that may be configured to execute one or more operations associated with the AI-based adaptive visualization of the set of digital artifacts. The set of agents 110 may be utilized by the processing circuitry 104 for the execution of the one or more operations associated with the AI-based adaptive visualization. Each agent of the set of agents 110 may be configured to communicate with remaining agents of the set of agents 110 for execution of one or more operations associated with the AI-based adaptive visualization of the set of digital artifacts.

The set of agents 110 may include, but is not limited to, a user interaction agent, an event processing agent, a belief state update agent, a visualization agent, a reinforcement learning agent, a probability and confidence scoring agent, a dependency analysis agent. The set of agents 110 may execute the one or more operations associated with the adaptive visualization of the digital artifacts (namely, the set of digital artifacts) sequentially or in parallelly. In some embodiments, the set of agents 110 may execute the one or more operations collectively to adaptively and dynamically visualize the digital artifacts to entities associated with the software product. Throughout the description, the phrase ‘visualization of the digital artifacts’ corresponds to ‘presentation or rendering of relevant digital artifacts to an entity associated with the set of digital artifacts’.

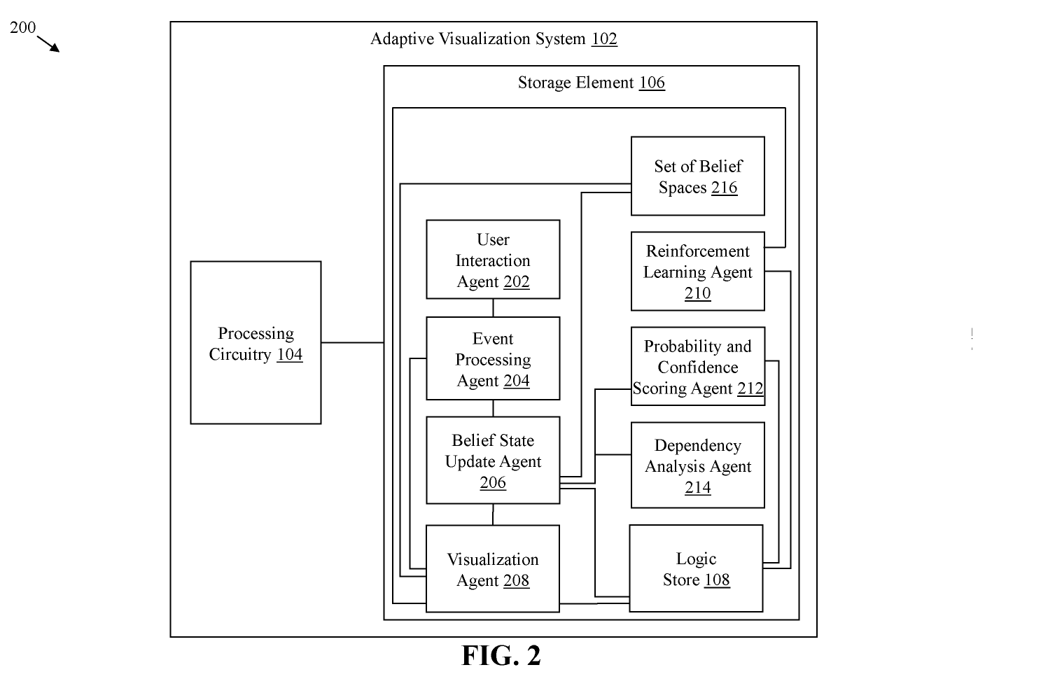

The processing circuitry 104 may further act as an orchestrator for the set of agents 110. For example, the processing circuitry 104 may be further configured to coordinate a sequence of operations executed by the set of agents 110. Each agent of the set of agents 110 may be configured to perform specific functions that, collectively, enable the adaptive visualization of the digital artifacts associated with the software product. For the sake of brevity, the set of agents 110 is illustrated and described in detail in conjunction with FIG. 2.

The logic store 112 may include computational elements such as rules, policies, constraints, heuristics, or machine-learned models that govern a way in which the visualization of the digital artifacts associated with the software product is performed. The logic store 112 further comprises a set of logic constraints that includes entity-specific and digital artifacts specific subsets of logic constraints pertaining to priority determination and weight generation for digital artifacts. The logic constraints define operational parameters, functional boundaries, prioritization criteria, and computational rules that control how the processing circuitry 104 or the set of agents 110 evaluates, ranks, and selects digital artifacts for adaptive visualization interface rendering. In some embodiments, the computational elements may be static such as predefined rules or regulations. In some embodiments, the computational elements may be dynamic, such as learned or updated based on user feedback patterns, reinforcement learning optimization, entity behavioral analysis, or contextual data associated with the set of entities and their role attributes. The terms ‘visualization interface’ and ‘adaptive visualization interface’ are used interchangeably.

The storage element 106 may implement a dual-memory architecture comprising distinct short-term memory and long-term memory components configured for optimized data management and retrieval operations. The short-term memory may be configured to store transient information associated with real-time events, current user actions, active user sessions, and immediate contextual data related to digital artifact interactions. The long-term memory may be configured to store persistent information, including role attributes corresponding to entities, historical user interaction patterns, established logic constraints, belief spaces associated with digital artifacts, and validated system learning outcomes. Data within the short-term memory may be periodically evaluated and processed through automated data lifecycle management, wherein a subset of data may be added to accommodate new user actions, deleted when determined to be obsolete or irrelevant, or promoted to the long-term memory based on predetermined criteria such as usage frequency, relevance scores, or validation through reinforcement learning feedback. The long-term memory may retain selected data from the short-term memory based on factors such as duration of storage in the short-term memory, statistical relevance to user behavior patterns, contribution to logic constraint optimization, or significance to belief state accuracy. The adaptive visualization system 102 may be further configured to autonomously learn and determine data retention policies, including which data should be maintained in the short-term memory for immediate access, transferred to the long-term memory for persistent storage, or discarded as irrelevant based on machine learning algorithms and system performance metrics. The adaptive visualization system 102 may visualize the subset of digital artifacts with reduced computational latency and enhanced processing efficiency through optimized memory management, enabling faster data retrieval, reduced storage overhead, and improved system scalability across multiple concurrent user entities.

The adaptive visualization system 102 may be coupled to a computing system that implements the software product or the set of digital artifacts. Each of the plurality of entities associated with the set of digital artifacts may be further associated with the computing system via a corresponding user device. Further, each entity of the plurality of entities may visualize a subset of digital artifacts of the set of digital artifacts that may be relevant thereto by way of the corresponding user device. Examples of a user device may include, but are not limited to, a laptop, a phone, a tablet, a phablet, or the like. The plurality of entities corresponds to various stakeholders associated with the set of digital artifacts. Examples of an entity may be an end user, a developer, a security analyst, a project manager, or the like.

As shown, the adaptive visualization system 102 is associated with a computing system 114 via the communication network 108. The computing system 114 is shown to be associated with user devices 116 and 118 that may be associated with first and second entities, respectively, associated with the computing system 114. The computing system 114 is shown to be associated with a set of digital artifacts 120 associated with a first software product. The first and second entities may access the set of digital artifacts 120 via the user devices 116 and 118, respectively. Notably, the first and second entities may be associated with the first software product with different capacities, roles, and access permissions. Hence, the first and second entities may require visualizing different subsets of digital artifacts of the set of digital artifacts 120. Also, a visualization requirement of the first and second entities may change over time with changes in tasks, roles, responsibilities, access permissions, or the like. Such dynamic and adaptive visualization of the set of digital artifacts 120 may be performed by the system 102. Similarly, the adaptive visualization system 102 may be further coupled to a computing system 122 via the communication network 108. In some embodiments, the set of digital artifacts 120 may be stored in the storage element 106. In another embodiment, the set of digital artifacts 120 may hosted on the computing system 114, and accessed by the system 102 via the communication network 108. For the sake of brevity of the present description, the set of digital artifacts 120 is a assumed to be hosted on the computing system 114, and accessed by the system 102. It will be apparent to a person skilled in the art that a first element (for example, a first digital artifact) mentioned in the claims may correspond to a second element described in the specification, and vice versa.

As shown, the adaptive visualization system 102 is associated with a computing system 122 via the communication network 108. The computing system 122 is shown to be associated with user devices 124 and 126 that may be associated with third and fourth entities, respectively, associated with the computing system 122. The computing system 122 is shown to be associated with a set of digital artifacts 128 associated with a second software product. The third and fourth entities may access the set of digital artifacts 128 via the user devices 124 and 126, respectively. Notably, the third and fourth entities may be associated with the second software product in different capacities. In other words, the third and fourth entities may be associated with the second software product in different roles. Hence, the third and fourth entities may require to visualize different subsets of digital artifacts associated with the set of digital artifacts 128. Also, the visualization requirement of the third and fourth entities may change over time. Such dynamic and adaptive visualization of the set of digital artifacts 128 may be performed by the system 102. Similarly, the adaptive visualization system 102 may be coupled to one or more other computing systems (not shown) via the communication network 108. For the sake of brevity, the ongoing description is described with respect to the first set of digital artifacts 120. It will be apparent to a person skilled in the art that adaptive visualization of the set of digital artifacts 128 or any other set of digital artifacts may be performed in a similar manner.

The first entity may visualize a corresponding relevant subset of digital artifacts of the set of digital artifacts 120 by way of a visualization interface 130 of the user device 116. Similarly, the second entity may visualize a corresponding relevant subset of digital artifacts of the set of digital artifacts 120 by way of a visualization interface 132 of the user device 118. The user devices 116 and 118 may host a user application, which may be an executable module of the adaptive visualization system 102 (namely, the system 102). The visualization interfaces 130 and 132 may present the user application to the first and second entities via the user devices 116 and 118, respectively. The user application may be used by the first and second entities to visualize a corresponding relevant subset of digital artifacts of the set of digital artifacts 120.

In an embodiment, the system 102 may communicate with the user device 116 to present the relevant subset of digital artifacts (for example, a first subset of digital artifacts of the set of digital artifacts 120) to the first entity via the visualization interface 130. The system 102 may execute one or more operations for identification of the first subset of digital artifacts from the set of digital artifacts 120 that may be relevant to the first entity.

In operation, the processing circuitry 104 may access a first set of role attributes corresponding to the first entity associated with the set of digital artifacts 120. The first set of role attributes may be retrieved from the storage element 106. The first set of role attributes may be stored in the long-term memory of the storage element 106. The first set of role attributes may be retrieved from the long-term memory. The first set of role attributes are indicative of at least one of one or more operational constraints or one or more functional constraints associated with the first entity.

An operational constraint may refer to one or more working practices, established routines associated with access and interaction with digital artifacts, habitual behaviors, workflow patterns, time-based access preferences, collaborative interaction methods, and other systematic practices of the first entity that influence, guide, or limit how the first entity operates with the set of digital artifacts 120 during their regular operational procedures.

A functional constraint may refer to predefined limitations, boundaries, and privileges that govern various permissions, responsibilities, and permissible actions of the first entity with respect to the set of digital artifacts 120. The functional constraints may be determined based on an assigned role and organizational position associated with the first entity. The functional constraints may include restrictions or authorizations for accessing, modifying, creating, deleting, or visualizing specific subsets of digital artifacts based on predefined access levels, security clearances, departmental policies, or organizational hierarchies that define a functional scope of operations the first entity is permitted to perform with respect to the set of digital artifacts 120.

In some embodiments, the first entity may correspond to an end user who primarily interacts with a visualization dashboard to monitor or review system performance metrics, task progress, or operational summaries. The end user may be subject to functional constraints that limit access to underlying implementation details, code-level interactions, or administrative functionalities, thereby ensuring secure and role-appropriate access. The end user’s focus may primarily lie in observing execution and outcomes of specific modules. Transaction monitoring, reporting, or workflow tracking, rather than analysing interdependencies or data flow between modules, may be focused on by the end user. For instance, an end user of a banking management system may review transaction success rates or customer service metrics without requiring visibility into how backend service modules or APIs (Application Programming Interfaces) interact to support those operations. Thus, high-level operational insights, task completion statuses, and performance summaries may be relevant to the entity, whereas complex relationships or technical dependencies among modules may be irrelevant to the end user.

The first set of role attributes corresponding to the first entity may represent contextual and behavioral data derived from the first entity’s interaction with the set of digital artifacts 120. The first set of role attributes may capture information such as type, frequency, and nature of operations performed by the first entity, such as a developer. For example, the developer interactions may include edits performed on the set of digital artifacts 120, navigation patterns of the developer, co-edit frequencies, or the like. The first set of role attributes may be recorded implicitly. For example, how the developers may actually work with the set of digital artifacts 120, rather than relying on direct user input or formal updates to a documentation (for example, version control histories or code analysis reports) associated with the set of digital artifacts. Therefore, the first set of role attributes may reflect an inherent context of day-to-day interaction of a given role of the first entity (for example, the developer) with the set of digital artifacts 120.

The processing circuitry 104 may be further configured to identify a first subset of digital artifacts from the set of digital artifacts 120 for the first entity. The first subset of digital artifacts may be relevant to the first entity and may be identified based on the first set of role attributes. In some embodiments, the first subset of digital artifacts may be identified based on at least one of the one or more operational constraints and one or more functional constraints. The first subset of digital artifacts comprises a contextually relevant collection of digital artifacts selected from the set of digital artifacts 120 based on their alignment with the first set of role attributes. The first subset of digital artifacts may be determined by analyzing the first set of role attributes that encompass both the functional constraints (defining what the first entity is authorized to access, modify, or visualize) and the operational constraints (reflecting the first entity's working practices, routines, and habitual behaviors with respect to the set of digital artifacts 120). The processing circuitry 104 may evaluate each digital artifact of the set of digital artifacts 120 against the functional constraints and the operational constraints associated with the first entity to determine contextual relevance and inclusion in the first subset of digital artifacts. In an embodiment, the identification of the first subset of digital artifacts may be performed based on detection of a change in at least one of the operational constraints and the functional constraints. Beneficially, such detection of relevant digital artifacts from the set of digital artifacts 120 based on a change in the first role attributes enables the system 102 to remain aware of a current relevance of each digital artifact of the set of digital artifacts 120 for the first entity.

In one embodiment, the identification of the first subset of digital artifacts based on the functional constraints may involve the processing circuitry 104 analyzing the first entity's role as a "developer" with the functional constraints that authorize access to source code files, test scripts, and configuration files, but restrict access to financial reports, executive dashboards, or human resources documentation. The processing circuitry 104 may identify and include only those digital artifacts in the first subset of digital artifacts that fall within the developer's authorized functional scope, such as Java source files, unit test cases, build configuration files, and technical documentation, while excluding one or more digital artifacts outside their functional permissions based on the functional constraints.

In another embodiment, identification based on the operational constraints may include the processing circuitry 104 analyzing the first entity's working practices, such as consistently accessing one or more digital artifacts of the set of digital artifacts 120 during specific time periods (e.g., morning code reviews), following particular workflows (e.g., always checking test results before code deployment), or demonstrating habitual interaction patterns (e.g., frequently accessing debugging logs when working on performance optimization tasks). The processing circuitry 104 may prioritize the one or more digital artifacts that align with these operational patterns, such as including recent test execution reports during morning hours or highlighting performance monitoring dashboards when the first entity's recent activities indicate debugging focus.

When considering the functional constraints and operational constraints collectively, the processing circuitry 104 may identify the first subset of digital artifacts for the first entity, who may be a "senior developer" and whose functional constraints authorize access to both development and architectural artifacts, while operational constraints indicate a routine of reviewing security vulnerability reports every Tuesday and conducting code quality assessments before major releases. The processing circuitry 104 may generate the subset of digital artifacts, based on the set of digital artifacts 120, that includes not only standard development artifacts (source code, tests) based on functional authorization, but also prioritizes security scanning results on Tuesdays and code quality metrics during pre-release periods, generating the first subset of digital artifacts that is contextually optimized for various permissions and established working patterns associated with the first entity.

The processing circuitry 104 of the system 102 may be configured to determine a first set of user actions associated with the first entity via the user device 116. The processing circuitry 104 may store the first set of user actions in the short-term memory of the storage element 106. The first set of user actions may include a plurality of interactive behaviors and engagement patterns executed by the first entity through the user device 116 during a predefined time interval. The first set of user actions may include, but are not limited to, navigation through digital artifact hierarchies, clickstreams indicating sequential artifact access, touch gestures for artifact selection and manipulation, scroll behaviors indicating content exploration depth, selection sequences revealing artifact preferences, dwell time measurements indicating engagement levels, query formulation patterns, interface interaction frequencies, and other input modalities and behavioral indicators employed to access, examine, modify, or interact with the set of digital artifacts. The first set of user actions during the predefined time interval may be indicative of a contextual significance of one or more digital artifacts for the first entity. The contextual significance may indicate that the first entity may require access to the one or more digital artifacts during a first time interval after the pre-defined time interval. The contextual significance may indicate relevance and priority of the one or more digital artifacts based on temporal operational needs, project deadlines, scheduled activities, role-specific responsibilities that are time-sensitive in nature, or the like associated with the first entity. To summarize, the first set may be associated with an underlying intent or purpose. The intent may correspond to a specific task the first entity seeks to accomplish within their operational workflow, an objective or goal the first entity aims to achieve in relation to their functional responsibilities, a particular problem-solving activity requiring specific digital artifact access, or a rationale driving the first entity's motive to access, analyze, or manipulate the one or more digital artifacts based on their role attributes, current project requirements, or immediate operational needs during the specified time interval. The processing circuitry 104 may analyze temporal patterns, interaction sequences, and contextual relationships within the first set of user actions to infer user intent and generate contextually appropriate prioritization for digital artifact selection and visualization interface rendering.

The predefined time interval refers to a monitoring duration established by the processing circuitry 104 using an agent of the set of agents 110 for continuous user activity analysis and intent determination. During the monitoring duration, the processing circuitry 104 observes and analyzes the first set of user actions to detect patterns, behaviors, and contextual cues that indicate the first entity's current operational focus, immediate objectives, or evolving task requirements. The system 102 utilizes this monitoring duration to dynamically determine user intent based on detected interaction patterns, navigation sequences, and engagement behaviors exhibited by the first entity through the user device 116.

The processing circuitry 104 leverages the predefined time interval to continuously adjust relevance determination and priority assessment for the one or more digital artifacts within the first subset of digital artifacts based on real-time analysis of user actions. For instance, when the processing circuitry 104 detects that the first entity is beginning to access user interface design modules through repeated navigation to UI-related artifacts, the relevance determination dynamically shifts to prioritize user interface components, design specifications, and related documentation within the first subset of digital artifacts. Similarly, if the processing circuitry 104 identifies that the first entity has initiated modifications to security permissions or accessed security-related configuration files, the system 102 automatically elevates the priority assessment of security-related digital artifacts, vulnerability assessments, and compliance documentation.

In some embodiments, the first subset of digital artifacts may encompass multiple categories such as user interface elements, security-related components, development tools, and documentation, but the relative relevance and priority assessment of each category fluctuates dynamically based on the detected intent of user actions during the monitoring duration. This dynamic relevance adjustment ensures that the visualization interface 130 presents the most contextually appropriate digital artifacts to the first entity without requiring manual reconfiguration or explicit user specification of preferences. The predefined time interval thus serves as a continuous feedback mechanism that enables the processing circuitry 104 to maintain current and responsive artifact prioritization aligned with evolving operational needs and immediate task focus of the first entity.

The processing circuitry 104 uses the first set of user actions to generate a first set of weights through computational analysis of the interactive behaviors and engagement patterns exhibited by the first entity. The processing circuitry 104 may determine the first set of weights further based on a first subset of logic constraints of the set of logic constraints stored in the logic store 112. The first subset of logic constraints pertains specifically to the priority determination and weight generation processes associated with the first entity and the first subset of digital artifacts. The processing circuitry 104 may access the logic store 112 to retrieve the first subset of logic constraints that includes computational rules governing priority assignment, predefined weight values for specific categories of digital artifacts, established priority hierarchies for different types of digital artifacts, and decision-making protocols that determine how the processing circuitry 104 evaluates and assigns weight values to digital artifacts based on the first set of user actions. The first subset of logic constraints may define rules for priority determination between competing digital artifacts, specify predefined weight values for artifacts based on their classification or importance level, establish priority rankings for different categories of digital artifacts such as security-related components receiving higher priority than documentation files, provide conditional logic for adjusting priorities based on temporal factors, frequency of access, or contextual significance, and include rules that automatically assign higher weights to recently modified digital artifacts, priorities that favor artifacts directly related to the first entity's current project assignments, or constraints that limit access to certain artifact categories based on the first entity's authorization level. The processing circuitry 104 may apply the first set of logic constraints as computational guidelines during the weight generation process and combine the analysis of user actions with the application of the first set of logic constraints to produce the weight values that reflect both the first entity's demonstrated preferences and the systematic rules governing artifact prioritization within the adaptive visualization system 102.

In some embodiments, the processing circuitry 104 may employ machine learning algorithms, pattern recognition techniques, or statistical analysis methods to evaluate the frequency, duration, sequence, and contextual significance of each user action within the first subset of digital artifacts. The generation of the first set of weights may involve analyzing temporal relationships between user actions, identifying recurring interaction patterns, assessing dwell times on specific digital artifacts, evaluating navigation pathways through artifact hierarchies, and determining correlation coefficients between user behaviors and artifact categories. The first set of weights indicates a priority associated with each digital artifact within the subset of digital artifacts. Each of the weight values represent a quantitative measure of priority, relevance, importance, or contextual significance of a corresponding digital artifact relative to the detected intent, operational requirements, role-specific needs, or the like associated with the first entity. The set of weights may be expressed as numerical values, probability distributions, ranking scores, or other quantitative indicators that enable the processing circuitry 104 to establish a hierarchical ordering of digital artifacts of the first subset of digital artifacts for selection and visualization interface rendering purposes. The processing circuitry 104 may dynamically adjust these weight values based on real-time analysis of ongoing user actions, ensuring that the priority indicators remain current and aligned with evolving operational focus and immediate task requirements of the first entity.

In an example, a developer addressing performance optimization may find modules related to data processing or API response handling more relevant than user interface components. Similarly, for a security analyst, during a security audit phase, modules associated with authentication and encryption may be prioritized over those handling visual layout or logging. In another instance, for a developer, when a new feature release is being developed, modules directly linked to that feature’s functionality may be considered of higher importance.

The processing circuitry 104 of the adaptive visualization system 102 may be configured to select at least a first digital artifact from the subset of digital artifacts. The selection of at least the first digital artifacts may be based on the first set of weights. The processing circuitry 104 may be configured to select the first digital artifact from the first subset of digital artifacts based on the set of weights and the first subset of logic constraints of the set of logic constraints in the logic store 112. The first subset of logic constraints may correspond to a predetermined relevance criterion of digital artifacts, within the first subset of digital artifacts, established for the first entity. The selection of at least the first digital artifacts may involve analyzing the weight values associated with each digital artifact within the first subset of digital artifacts, comparing the weights values against selection parameters, and applying filtering algorithms to identify the most contextually relevant digital artifacts. The processing circuitry 104 may implement various selection methodologies to determine which digital artifacts should be presented to the first entity based on their calculated priority levels, role attributes, and current operational context.

In some embodiments, the processing circuitry 104 may select a predefined count of digital artifacts from the first subset of digital artifacts with the highest weights, thereby prioritizing digital artifacts that have been determined to be most relevant or significant to the first entity's current operational needs. For example, the processing circuitry 104 may be configured to select the top five, ten, or twenty digital artifacts with the highest weight values, ensuring that the visualization interface 130 displays a manageable number of high-priority artifacts without overwhelming the first entity with excessive information. Such an approach of selecting the digital artifacts enables consistent presentation of a fixed quantity of most relevant digital artifacts regardless of the total number of artifacts in the first subset of digital artifacts.

In other embodiments, the processing circuitry 104 may select digital artifacts with weights greater than a predetermined threshold value, ensuring that only digital artifacts meeting a minimum relevance criterion are chosen for visualization interface rendering. The threshold value may be dynamically adjusted based on performance metrics, user feedback patterns, or contextual factors such as project urgency or operational complexity. The threshold-based selection approach described herein allows for variable numbers of digital artifacts to be selected depending on how many digital artifacts exceed the relevance threshold, providing flexibility in presentation based on the current operational context and ensuring that only sufficiently relevant artifacts are displayed to the first entity. Throughout the description, the terms ‘digital artifacts’ and ‘artifacts’ are used interchangeably.

In some embodiments, the processing circuitry 104 may select only the first digital artifact from the first subset of digital artifacts. In some embodiments, in addition to the first digital artifact, the processing circuitry 104 may select a second digital artifact from the first subset of digital artifacts. The second digital artifact may be selected in a manner similar to the selection of the first digital artifact.

The processing circuitry 104 may be further configured to render the first digital artifact via the visualization interface 130 of the user device 116. Based on the selection of the second digital artifact, the processing circuitry 104 may be further configured to render the second digital artifact in addition to rendering the first digital artifact via the visualization interface 130.

Notably, the first entity's user actions may vary significantly depending on their intended objectives and operational goals, wherein different tasks, project requirements, or functional responsibilities necessitate distinct interaction patterns and consequently result in the selection of different digital artifacts from the first subset for rendering purposes through the visualization interface 130. Such variability in user intent and corresponding action patterns requires the visualization of digital artifacts to be adaptive. To ensure such adaptive and dynamic visualization of digital artifacts, the processing circuitry 104 dynamically analyzes user actions to determine contextual relevance and selects the most appropriate digital artifacts from the first subset of digital artifacts that align with the first entity's current operational focus, immediate task requirements, or evolving project needs. The adaptive nature of visualization enabled by the system 102 ensures that the rendered digital artifacts are tailored specifically to the first entity's detected intent and role-specific requirements, providing contextually relevant information without requiring manual configuration or explicit artifact specification by the first entity. Furthermore, the first subset of digital artifacts undergoes periodic evaluation and updating by the processing circuitry 104 to ensure that the most pertinent, current, and contextually relevant digital artifacts, of the set of digital artifacts 120, for the first entity remain available within the first subset of digital artifacts for selection and rendering, thereby maintaining the accuracy and effectiveness of the adaptive visualization system 102 as the first entity's role attributes, project assignments, or operational responsibilities evolve over time.

In some embodiments, the first set of role attributes corresponding to a first entity may differ from a second set of role attributes corresponding to a second entity associated with the same set of digital artifacts. Variations in the set of role attributes may result in distinct visualization outputs for each entity. For example, a developer may require detailed structural or dependency-level visualizations to support debugging and performance optimization, whereas a project manager may require high-level progress or risk-oriented visualizations emphasizing module status and task completion metrics. Accordingly, the adaptive visualization system 102 may dynamically adjust the visualization of digital artifacts based on the role, objectives, and interaction patterns of the entity, thereby ensuring that the visualization remains contextually relevant and task-oriented for each user.

In some embodiments, the processing circuitry 104 is further configured to determine a second set of role attributes corresponding to a second entity of the plurality of entities associated with the set of digital artifacts 120. The second set of role attributes is indicative of at least one of one or more operational constraints or one or more functional constraints associated with the second entity. The processing circuitry 104 is further configured to identify, based on the second set of role attributes, a second subset of digital artifacts from the set of digital artifacts 120. The second subset of digital artifacts is contextually associated with the second set of role attributes. The processing circuitry 104 is further configured to determine a second set of user actions associated with the second entity via the user device 118. The second set of user actions is determined for the predefined time period. The processing circuitry 104 is further configured to generate, based on the second set of user actions, a second set of weights for the second subset of digital artifacts. The second set of weights is indicative of a priority associated with each of the second subset of digital artifacts for the second entity. The processing circuitry 104 is further configured to select at least a third digital artifact from the second subset of digital artifacts based on the second set of weights. The processing circuitry 104 is further configured to render, via a second visualization interface of the second user device, at least the third digital artifact. The selection of the third digital artifact may be performed in a manner similar to the selection of the first digital artifact. In some embodiments, the first subset of digital artifacts and the second subset of digital artifacts may be unique. In some embodiments, the first subset of digital artifacts and the second subset of digital artifacts may include common digital artifacts and hence, may overlap with each other.

In some embodiments, the processing circuitry 104 may be further configured to receive a user query via the visualization interface 130 of the user device 116 associated with the first entity. The user query may pertain to one or more digital artifacts of the set of digital artifacts 120.

The user query may include natural language text, voice commands, structured search expressions, or interactive selections that specify search criteria, filtering parameters, analytical operations, or visualization preferences to be performed on the set of digital artifacts 120. In various embodiments, the user query may include keywords, phrases, Boolean operators, semantic expressions, role-specific terminology, or domain-specific language that defines the scope, intent, and operational requirements of a requested digital artifact retrieval or analysis operation. The user query may be submitted through various input modalities, including text input fields, voice recognition interfaces, dropdown menus, or interactive selection mechanisms provided by the visualization interface 130.

The processing circuitry 104 may be further configured to determine a context of the user query based on a set of tokens associated with the user query. The set of tokens associated with the user query may be generated through tokenization processes that parse the user query into discrete linguistic, semantic, or conceptual units using natural language processing algorithms, lexical analysis techniques, or domain-specific parsing methods. The set of tokens may include individual words, multi-word phrases, n-grams, semantic identifiers, entity names, attribute descriptors, or relationship indicators that represent concepts, operations, constraints, or relationships within the user query. The set of tokens may be processed using advanced natural language processing techniques, including stemming, lemmatization, named entity recognition, part-of-speech tagging, or semantic analysis to extract meaningful components that can be mapped to digital artifact attributes, metadata fields, or system functionalities.

The context of the user query may be determined by analyzing the relationships between the set of tokens, their semantic meanings, syntactic structures, and their relevance to the digital artifacts within the set of digital artifacts 120. The context may encompass the first entity's operational intent, the domain of inquiry, temporal constraints, priority requirements, role-specific access patterns, or specific attributes, metadata, or characteristics of the digital artifacts that are contextually relevant to the user query. The processing circuitry 104 may utilize the determined context to filter, prioritize, and select appropriate digital artifacts from the first subset of digital artifacts that align with the user's expressed requirements and operational objectives.

Example: A first entity with a developer role may submit a user query "show security vulnerabilities in payment processing modules modified last week" via the visualization interface 130. The processing circuitry 104 may tokenize this query into tokens such as ["show", "security", "vulnerabilities", "payment", "processing", "modules", "modified", "last week"]. Based on these tokens, the processing circuitry 104 may determine that the context involves retrieving digital artifacts related to security assessment with domain-specific filtering (payment processing), temporal constraints (last week), and attribute-specific requirements (security vulnerabilities), enabling the system 102 to select and render relevant digital artifacts from the first subset of digital artifacts that match the developer's operational needs and security analysis objectives.

The processing circuitry 104 may be further configured to identify a third subset of digital artifacts of the set of digital artifacts 120 based on at least one of: the context of the user query or the first set of role attributes. The identification of the third subset of digital artifacts involves analyzing the semantic content, operational intent, and contextual parameters derived from the user query to determine selection criteria that guide the filtering and categorization of digital artifacts within the set of digital artifacts 120. The processing circuitry 104 may implement computational algorithms that evaluate each digital artifact within the set of digital artifacts 120 against predetermined criteria derived from the context of the user query, including but not limited to keyword matching, semantic similarity analysis, metadata correlation, or attribute-based filtering that identifies digital artifacts relevant to the expressed requirements of the first entity. Additionally, the processing circuitry 104 may utilize the first set of role attributes to establish authorization boundaries, functional constraints, and operational limitations that determine which digital artifacts the first entity is permitted to access, modify, or visualize. Hence, the processing circuitry 104 thereby ensures that the third subset of digital artifacts complies with role-specific permissions and organizational policies. The identification process may involve cross-referencing the contextual requirements derived from the user query with the functional and operational constraints defined by the first set of role attributes to generate the third subset of digital artifacts that satisfy both the user's expressed needs and the first entity's authorized access scope.

The processing circuitry 104 may be configured to generate a weighted arrangement of the third subset of digital artifacts based on a second subset of logic constraints of the set of logic constraints stored in the storage element 106. A weighted arrangement of the third subset of digital artifacts refers to an ordered configuration where each digital artifact within the third subset is assigned a numerical weight value indicating its relative importance or priority. The digital artifacts are systematically organized according to these weight values to facilitate prioritized selection and visualization processes. The second subset of logic constraints pertains to the priority determination and weight calculation processes associated with the first subset of digital artifacts for the first entity. The processing circuitry 104 may access the storage element 106 to retrieve the second subset of logic constraints that includes computational rules, predefined weight values, priority hierarchies, and decision-making protocols specifically applicable to the weighted arrangement generation process for the third subset of digital artifacts. The weighted arrangement may be generated by applying the second subset of logic constraints to evaluate each digital artifact within the third subset of digital artifacts according to established priority criteria, relevance factors, and contextual significance parameters defined within the logic constraints. The processing circuitry 104 may utilize the second subset of logic constraints to assign numerical weight values to each digital artifact within the third subset of digital artifacts, wherein the weight values reflect the relative importance, priority ranking, or contextual relevance of each digital artifact based on the first entity's role attributes, operational requirements, and the context of the user query. The second subset of logic constraints may include rules for priority determination between competing digital artifacts, conditional logic for adjusting weights based on temporal factors or contextual conditions, and algorithmic parameters that govern how different categories of digital artifacts should be weighted relative to one another within the third subset of digital artifacts. The resulting weighted arrangement enables the processing circuitry 104 to establish a hierarchical ordering of digital artifacts within the third subset of digital artifacts that facilitates subsequent selection, filtering, and visualization processes tailored to the first entity's specific operational needs and query requirements.

In some embodiments, the processing circuitry 104 may further be configured to apply ranking algorithms, relevance scoring mechanisms, or priority assessment protocols to order the digital artifacts within the third subset based on their contextual significance to the user query and their alignment with the first entity's role-specific requirements, enabling subsequent selection and visualization processes to present the most appropriate digital artifacts to the first entity through the visualization interface 130.

The processing circuitry 104 may be further configured to render, via the first visualization interface of the first user device, one or more digital artifacts of the third subset of digital artifacts based on the weighted arrangement of the third subset of digital artifacts. The one or more digital artifacts are rendered in response to the user query. The selection of one or more digital artifacts for rendering from the third subset may be performed by (i) identifying digital artifacts with the highest weight values within the weighted arrangement, (ii) selecting a predetermined number of top-ranked digital artifacts based on their priority scores, or (iii) applying threshold-based selection criteria that include only digital artifacts exceeding a minimum weight value. The processing circuitry 104 may alternatively select the third subset of digital artifacts for rendering based on their direct correlation to specific tokens identified within the user query, their semantic alignment with the determined context of the user query, or their functional relevance to one or more operational objectives expressed in the user query. The rendered digital artifacts respond to and relate to the user query by providing contextually appropriate information, functionality, or data that directly addresses the user's expressed requirements, wherein the digital artifacts may include source code modules that match query-specified programming languages or frameworks, documentation files that contain keywords or concepts referenced in the user query, configuration files that relate to components mentioned in the user query, or analytical reports that correspond to the temporal constraints or operational domains specified within the user query. Such selection of the third subset of digital artifacts ensures that the rendered third subset of digital artifacts maintains semantic coherence with the user's intent and provides actionable information that enables the first entity to accomplish their specified operational objectives or analytical tasks as expressed through the user query.

The processing circuitry 104 may utilize one or more of the set of agents 110 for execution of one or more operations performed thereby for the selection and rendering of the first and second digital artifacts. Various operations performed based on the utilization of the set of agents 110 are described with respect to each agent of the set of agents 110 in conjunction with FIG. 2.

It will be apparent to a person skilled in the art that the system environment 100 shown in FIG. 1 is exemplary and does not limit the scope of the description.

FIG. 2 is a block diagram 200 that illustrates the adaptive visualization system 102 of the system environment 100 of FIG. 1, consistent with disclosed embodiments of the present disclosure. For the sake of brevity, FIG. 2 is explained in conjunction with elements from FIG. 1. Referring to FIG. 2, the adaptive visualization system 102 is shown to include the processing circuitry 104 that is coupled to the storage element 106 as described in conjunction with FIG. 1.

As mentioned previously, the storage element 106 is configured to store the set of agents 110 (shown in FIG. 1) and the logic store 112. The set of agents 110 may include the user interaction agent (hereinafter, the user interaction agent 202), the event processing agent (hereinafter, the event processing agent 204), the belief state update agent (hereinafter, the belief state update agent 206), the visualization agent (hereinafter, the visualization agent 208), the reinforcement learning agent (hereinafter, the reinforcement learning agent 210), the probability and confidence scoring agent (hereinafter, the probability and confidence scoring agent 212), and the dependency analysis agent (hereinafter, the dependency analysis agent 214). The storage element 106 may be further configured to store a set of belief spaces 216 associated with the set of digital artifacts 120.

In some embodiments, the processing circuitry 104 may maintain a set of belief spaces associated with the set of digital artifacts 120. The processing circuitry 104 may utilize one or more agents of the set of agents 110 for maintenance of the set of belief spaces. The processing circuitry may store the set of belief spaces in the storage element 106. That is, the storage element 106 may be configured to store the set of belief spaces. The set of belief spaces includes a set of belief types, and each belief type is associated with a corresponding belief state of a set of belief states that indicate a current state of specific attributes of digital artifacts within that belief type category. A belief space associated with a first digital artifact may include a first set of belief types associated with a first set of belief states. A first belief state of the first set of belief states may be associated with a first belief type of the first set of belief types, with the first belief type being indicative of a first attribute pertaining to the first digital artifact. The first belief state may represent a probabilistic or deterministic assessment of condition, status, or characteristic of the first digital artifact with respect to the first attribute. Such representation of the set of digital artifacts 120 by way of the set of beliefs enables the system 102 to maintain a comprehensive understanding of an ecosystem of the set of digital artifacts 120 and make informed decisions regarding visualization interface rendering and artifact prioritization for the first entity.

The belief spaces for digital artifacts 120 may include various belief types such as, but not limited to, a security vulnerability belief type having a belief state indicating whether a digital artifact contains high-risk vulnerabilities, medium-risk vulnerabilities, low-risk vulnerabilities, or no detected vulnerabilities; a performance hotspot belief type having a belief state indicating whether a digital artifact exhibits critical performance issues, moderate performance concerns, minor performance impacts, or optimal performance characteristics; a code maintainability belief type having a belief state indicating whether a digital artifact demonstrates high maintainability with clean code structure, moderate maintainability requiring minor improvements, low maintainability necessitating significant refactoring, or poor maintainability requiring complete restructuring; a documentation completeness belief type having a belief state indicating whether a digital artifact has comprehensive documentation, partial documentation, minimal documentation, or no documentation; a test coverage belief type having a belief state indicating whether a digital artifact has extensive test coverage above predetermined thresholds, adequate test coverage meeting minimum requirements, insufficient test coverage below acceptable levels, or no test coverage; and a developer interaction frequency belief type having a belief state indicating whether a digital artifact experiences frequent developer access and modification, moderate interaction levels, occasional access, or rare interaction patterns. Each belief state corresponds to and indicates the current assessed condition of a specific attribute of the associated digital artifact within its respective belief type, enabling the processing circuitry 104 to evaluate digital artifacts across multiple dimensions and generate contextually appropriate weights for visualization interface processing.

In some embodiments, a belief space may refer to a logical construct or data structure associated with a digital artifact that encapsulates contextual information, operational parameters, and behavioral indicators related to that digital artifact. Each belief space may contain one or more belief types, where a belief type represents a specific category or aspect of the digital artifact’s operational characteristics. Belief types may be performance, security compliance, code stability, or error frequency. Correspondingly, a belief state may denote a quantified or descriptive condition of a corresponding belief type at a given point in time, such as performance degradation detected or security compliance is for example 95%. Belief states may dynamically evolve in response to real-time events, user interactions, or updates to associated digital artifacts, enabling the adaptive visualization system 102 to maintain a continuously updated and contextually aware representation of artifact health, relationships, and system-wide dependencies.

Each digital artifact of the set of digital artifacts 120 may be associated with a belief space of the set of belief spaces 216. That is to say, the set of digital artifacts 120 may be associated with a set of belief spaces 216. A belief space may be indicative of all possible perceptions, estimates, or probability-based representations of conditions associated with the set of digital artifacts 120. These conditions may include configuration settings of the set of digital artifacts 120, operating mode of the set of digital artifacts 120, version or update status of the set of digital artifacts 120, performance metrics (for example, memory usage, response time, throughput) of the set of digital artifacts 120, errors associated with the set of digital artifacts 120, security status (for example, vulnerabilities, access permissions) of the set of digital artifacts 120, dependency of the set of digital artifacts 120 with libraries, services, or other digital artifacts of the set of digital artifacts 120, entity interaction associated with the set of digital artifact 120, or the like.

In some embodiments, the processing circuitry 104 may be configured to identify a first belief space of the set of belief spaces 216 associated with the first digital artifact. The processing circuitry 104 may be configured to determine a subset of belief types from a first set of belief types associated with the first belief space. The determination may be based on a context of the first set of user actions. For example, in case the context of the first set of user actions indicates that the first entity intends to commit a change to the first digital artifact. Therefore, a code commit belief type and/or a performance hotspot belief type may be selected from the first set of belief types. The processing circuitry 104 may be further configured to render the subset of belief types and a corresponding set of belief states associated with the subset of belief types. The rendering may occur via the visualization interface 130.

An occurrence of an event associated with the set of the digital artifact 120 may alter the set of belief spaces 216 associated with the set of belief types. In an embodiment, the event associated with the set of digital artifacts 120 may correspond to configuration changes, for example, modifications to parameters included within the set of digital artifacts 120. In some embodiments, the event associated with the set of digital artifacts 120 may correspond to an update in a version of the set of digital artifacts 120, for example, installing patches, upgrades, or rolling back to earlier versions. In some embodiments, the event associated with the set of digital artifacts 120 may correspond to performance changes of the set of digital artifacts 120, for example, variations in memory usage, CPU load, latency, throughput, or the like. In some embodiments, the event associated with the set of digital artifacts 120 may correspond to the occurrence of an error or fault in the set of digital artifacts 120, for example, new exceptions, crashes, or recovery from prior faults. In some embodiments, the event associated with the set digital artifacts 120 may correspond to security changes, for example, detection of vulnerabilities, integrity issues, permission updates, or access violations. In some embodiments, the event associated with the set of digital artifacts 120 may correspond to dependency changes, for example, updates, removals, or failures in linked libraries, APIs, or services associated with the set of digital artifacts 120.

The processing circuitry 104 may be further configured to access the storage element 106 directly or via the communication network 108 to coordinate various operations executed by each agent of the set of agents 110. In some embodiments, the set of agents 110 may include additional or different agents that may be configured to execute one or more operations associated with the adaptive visualization of the digital artifacts without deviating from the scope of the disclosure.

The set of agents 110 stored in the storage element 106 may refer to a collection of autonomous or semi-autonomous computational modules, each configured to perform specific tasks or subtasks for execution of one or more operations associated with the adaptive visualization of the digital artifacts (for example, visualization of the first set of digital artifacts 120 associated with the first entity). The set of agents 110 may include generative artificial intelligence (AI)-based agents and agentic AI-based agents. The generative AI-based agents may utilize generative models (such as large language models or diffusion models) to create content, generate responses, or synthesize data based on learned patterns whereas the agentic AI-based agents may be capable of goal-directed behavior, operate with a degree of autonomy, and may interact with other agents or components to plan, execute, and adapt actions in pursuit of defined objectives and goals, while exhibiting traits such as reasoning, decision-making, and feedback incorporation. Each agent of the set of agents 110 may operate independently or collaboratively with one or more other agents of the set of agents 110. In some embodiments, operations executed by each agent may be coordinated by the processing circuitry 104.

The processing circuitry 104 utilizes the user interaction agent 202 configured to determine the first set of user actions. To determine the first set of user actions, the user interaction agent 202 may be configured to monitor the visualization interface 130 of the user device 116 and record user actions via the visualization interface 130. The user interaction agent 202 may be an AI-based agent that employs artificial intelligence algorithms to analyze and interpret user behavior patterns. The user interaction agent 202 may record, based on the monitoring, the first set of user actions via the visualization interface 130 of the user device 116. More specifically, the user interaction agent 202 may be implemented as an agentic AI-based system. The user interaction agent 202 operates autonomously with goal-directed behavior, decision-making capabilities, and has ability to adapt its actions based on environmental feedback and user interactions. The user interaction agent 202 collects both explicit feedback received directly from users and implicit feedback tracked through user interaction patterns with the set of digital artifacts 120. The user interaction agent 202 utilizes machine learning algorithms to perform pattern analysis and extract implicit feedback based on a pattern/approach in which the users interact with the set of digital artifacts 120. Negative interaction patterns, such as repeated query reformulations, signal dissatisfaction and prompt the reinforcement learning agent 210 to adjust logic constraints stored in the storage element 106 to minimize conflicts and contradictions in responses. Positive interaction patterns, indicated by behaviors such as extended content exploration or increased system interaction, reinforce effective system behaviors through weight adjustments.

The user interaction agent 202 may be configured to track and interpret interactions initiated by the first entity associated with the user device 116. In some embodiments, the user interaction agent 202 may monitor both explicit entity inputs (for example, queries, commands, or task specifications) and implicit entity behavior (for example, navigation choices or time spent in a shared workspace environment). The user interaction agent 202 may further capture the entity's intent in conjunction with the shared context (for example, a co-inhabited workspace with other entities). The user interaction agent 202 may learn context-aware interpretation of the first entity's actions. Based on interpreted entity intent and context, the user interaction agent 202 may categorize entities request and retrieve a relevant set of belief types associated with the digital artifacts 120. Interactions captured by the user interaction agent 202 may be structured into standardized formats and transmitted to other agents of the set of agents 110 (for example, the belief state update agent 206 and visualization agent 208) for further analysis.

User interactions with any of the set of digital artifacts 120 and events associated with any of the set of digital artifacts 120 are detected by an event processing agent 204 stored in the storage element and utilized by the processing circuitry 104. The event processing agent 204 may be an AI-based system that employs artificial intelligence algorithms to monitor, capture, and categorize various events occurring within the digital artifact ecosystem. The event processing agent 204 may be implemented as an agentic AI-based system. The event processing agent 204 may operate autonomously to detect events such as code commits, bug reports, security incidents, system updates, and user activity changes without requiring manual intervention. The event processing agent 204, which may be an AI-based agent, may possess goal-directed behavior focused on real-time event detection and classification. The event processing agent 204 may have decision-making capabilities to determine event significance and impact, and adaptive learning mechanisms to improve event recognition accuracy over time. The event processing agent 204 may be configured to monitor event sources (e.g., bug trackers, code repositories, security logs), categorize events, and initiate analysis of potentially affected belief states associated with each digital artifact of the set of digital artifacts 120. Further, the event processing agent 204 may leverage automated detection and classification of impactful events to enable real-time updates associated with the overall performance of the computing system 114, thereby aiding in rapid response to issues, reducing manual overhead, and accelerating remediation cycles. The real-time update and rapid responses to issues may further aid in computational efficiency and reliability of the computing system 114.

In some embodiments, the processing circuitry 104 is further configured to utilize the event processing agent 204 to detect a first event associated with the first digital artifact. The first digital artifact may be associated with at least a fourth digital artifact of the first subset of digital artifacts. That is to say that the event processing agent 204 may detect the first event associated with the first digital artifact. The event processing agent 204 may monitor various event sources, including system logs, user activity streams, code repositories, security monitoring systems, or external data feeds, to identify events that impact or relate to digital artifacts within the set of digital artifacts 120. The first digital artifact may be associated with at least a fourth digital artifact of the first subset of digital artifacts through dependency relationships, functional connections, semantic similarities, or operational interdependencies that link the digital artifacts within the software ecosystem. The detected first event may indicate changes, modifications, updates, security incidents, performance issues, or other significant occurrences that affect the first digital artifact and potentially impact related digital artifacts within the first subset of digital artifacts. The processing circuitry 104 may be configured to analyze the detected first event to determine its scope of impact, identify which additional digital artifacts within the first subset of digital artifacts may be affected by the first event, and trigger appropriate updates to the belief spaces, logic constraints, or weight calculations associated with the impacted digital artifacts. The event processing agent 204 may further be configured to categorize the first event based on event type, severity level, source reliability, or potential impact scope, and apply appropriate processing protocols and update mechanisms for the first digital artifact and any associated digital artifacts within the first subset of digital artifacts that may be influenced by the detected first event.

In some embodiments, the processing circuitry 104 is further configured to utilize the event processing agent 204 to select at least the fourth digital artifact based on the detection of the first event. That is to say that the event processing agent 204 is configured to select at least the fourth digital artifact based on the detection of the first event. Subsequently, the visualization agent 208 is configured to render, based on the first event, the first digital artifact in association with at least the fourth digital artifact via the visualization interface 130 associated with the user device 116. In some embodiments, the association between the first digital artifact and the fourth digital artifact may be a semantic association or a syntactic association. The association between the first digital artifact and the fourth digital artifact may be the semantic association when the first and fourth digital artifacts are functionally related through shared operational purpose, business logic dependencies, or conceptual relationships within the set of digital artifacts 120, where both the first and fourth digital artifacts contribute to achieving common objectives or processing related data domains. For example, if the first digital artifact is a user authentication module and the fourth digital artifact is a user profile management system, they are semantically associated through their shared involvement in user account operations and security management functions. The association between the first digital artifact and the fourth digital artifact may be the syntactic association when the first and fourth digital artifacts are structurally connected through direct code dependencies, function calls, data structure sharing, or interface definitions that create explicit programmatic relationships between the first and fourth artifacts. For example, if the first digital artifact is a database connection class and the fourth digital artifact is a data access layer module, they are syntactically associated through import statements, method invocations, or shared variable declarations that establish direct code-level connections between the two artifacts.

The processing circuitry 104 may utilize the visualization agent 208 for the selection of at least the first digital artifact. The visualization agent 208 may receive the first set of user actions from the user interaction agent 202. The visualization agent 208 may be configured to determine a set of prioritization criteria associated with the first entity based on at least one of: the first set of role attributes corresponding to the first entity's functional and operational constraints within the adaptive visualization system 102, or the first set of user actions representing the interactive behaviors and engagement patterns exhibited by the first entity during the predefined time interval. The set of prioritization criteria may include computational parameters, ranking factors, relevance indicators, and decision-making rules that collectively define how digital artifacts within the first subset of digital artifacts should be evaluated, ordered, and selected for visualization interface rendering purposes. The set of prioritization criteria is indicative of the priority associated with the first subset of digital artifacts for the first entity, wherein each prioritization criterion within the set of prioritization criteria may correspond to specific aspects of digital artifact relevance, importance, or contextual significance relative to the first entity's operational requirements, current task focus, or role-specific responsibilities. The visualization agent 208 may analyze the first set of role attributes to extract prioritization factors such as functional authorization levels, operational workflow patterns, security clearance requirements, or departmental policy constraints, and may simultaneously evaluate the first set of user actions to identify behavioral indicators such as interaction frequency, navigation patterns, dwell time measurements, or selection preferences that inform the prioritization criteria determination process.

In an embodiment, the set of prioritization criteria is determined further based on an analytic hierarchy process (AHP), wherein the visualization agent 208 may implement AHP methodologies to structure the prioritization decision-making process into hierarchical levels, perform pairwise comparisons between different prioritization factors, calculate relative importance weights for each criterion, and generate a comprehensive prioritization framework that accounts for multiple competing factors and their interdependencies. In other embodiments, the set of prioritization criteria is determined further based on any other prioritization technique known in the art.

The AHP implemented herein for the determination of the set of prioritization criteria may be a structured multi-criteria decision-making technique that decomposes complex problems into a hierarchy of goals, criteria, and alternatives, enabling systematic evaluation and prioritization. The AHP converts subjective judgments into quantitative priority weights through mathematical analysis of pairwise comparisons. The AHP operates by structuring decision problem into hierarchical levels, performing pairwise comparisons among elements using a standardized scale, and organizing them into comparison matrices. Eigenvalue analysis is applied to derive normalized priority weights and assess consistency. Final priority scores are obtained through hierarchical synthesis, where local priorities are aggregated across all levels to determine global rankings of alternatives.

For digital artifact prioritization within the adaptive visualization system 102, the AHP may be implemented by defining a hierarchical structure where the overall goal may be optimal digital artifact selection for a specific entity (for example, the first entity). The set of prioritization criteria may include factors such as relevance to user role, frequency of access, security importance, performance impact, and contextual significance to current tasks. The processing circuitry 104 may construct pairwise comparison matrices by analyzing a set of user actions, a set of role attributes, and logic constraints stored in the logic store 112 to determine relative importance of each criterion for the specific entity and operational context.

The visualization agent 208 may generate the first set of weights based on the set of prioritization criteria by applying the determined criteria to evaluate each digital artifact within the first subset of digital artifacts, calculating numerical weight values that reflect the relative priority of each digital artifact according to the established criteria, and producing a quantitative ranking system that enables the processing circuitry 104 to select and render the most contextually appropriate digital artifacts for the first entity's visualization interface.

In some embodiments, the visualization agent 208 may generate the first set of weights by calculating priority weights for each evaluation criterion and applying the priority weights to evaluate each digital artifact within the first subset of digital artifacts. Each digital artifact of the first subset of digital artifacts may be assigned scores based on its attributes, metadata, and relationship to the first entity's operations. Final priority scores for digital artifacts are computed through weighted aggregation. AHP-based prioritization enables the adaptive visualization system 102 to generate quantitative rankings of digital artifacts that account for multiple factors. The AHP provides a mathematical foundation for selection of digital artifacts. Higher priority scores generated through the AHP for some digital artifacts may receive greater prominence for visualization, and lower priority scoring artifacts may be filtered out or presented with reduced emphasis based on established selection criteria and threshold values.

The visualization agent 208 may be an AI-based system employing artificial intelligence algorithms to generate, customize, and dynamically adapt visual representations of the set of digital artifacts 120 based on contextual analysis of user interactions, role attributes, and digital artifact characteristics. The visualization agent 208 may be implemented as an agentic AI-based system that operates autonomously to create role-specific visualizations, prioritize information display, and adapt interface elements in real-time. The visualization agent 208, which is agentic AI-based, possesses goal-directed behavior focused on optimizing information presentation for each user entity. The visualization agent 208 may perform decision-making to determine which digital artifacts and visual elements should be prominently displayed based on role attributes and user actions. The visualization agent 208 may have adaptive learning mechanisms to continuously improve visualization effectiveness through user feedback analysis. Interactions include behaviors such as repeated query reformulations, extended content exploration, or increased system engagement. The visualization agent 208 processes the interactions to generate updated weights and adjust visual representations over time. For example, the processing circuitry 104 may increase edge thickness between associated digital artifacts or modify node display characteristics based on updated priority weights. The visualization interface changes result from automated weight updates and logic constraint modifications rather than manual interface adjustments.

In some embodiments, the processing circuitry 104 is further configured to utilize the visualization agent 208 for the selection of the first digital artifact based on the first set of weights. The visualization agent 208 is further configured to generate the first set of weights based on the first subset of logic constraints of the set of logic constraints. The visualization agent 208 may access and retrieve the first subset of logic constraints that are specifically associated with the first entity and their corresponding digital artifact prioritization requirements. The visualization agent 208 may apply the computational rules, predefined weight values, priority hierarchies, and decision-making protocols contained within the first subset of logic constraints to systematically evaluate each digital artifact within the first subset of digital artifacts and calculate corresponding weight values that reflect the relative importance, relevance, or contextual significance of each digital artifact according to the established logic constraint parameters. The first subset of logic constraints may provide the visualization agent 208 with specific guidelines for weight calculation methodologies, threshold values for minimum and maximum weight assignments, conditional logic for adjusting weights based on temporal factors or contextual conditions, and priority ranking systems that determine how different categories of digital artifacts should be weighted relative to one another. The visualization agent 208 may further be configured to combine the logic constraint-based weight calculations with analysis of the first set of user actions and the first set of role attributes associated with the first entity, thereby generating the first set of weights through a comprehensive evaluation process that incorporates both the systematic rules defined in the first subset of logic constraints and the dynamic contextual factors derived from the first entity's operational behavior and role-specific requirements within the adaptive visualization system 102. Subsequently, the visualization agent 208 may select the first digital artifact based on the first set of weights.

In some embodiments, the visualization agent 208 is configured to determine a context associated with the first set of user actions by analyzing the interactive behaviors, engagement patterns, and temporal relationships exhibited by the first entity during the predefined time interval to identify underlying operational objectives, task-specific requirements, or evolving workflow patterns that indicate the first entity's current operational focus and immediate needs. The visualization agent 208 is further configured to generate, based on the determined context, a set of user feedback associated with the first entity by interpreting the contextual information to derive implicit feedback signals, satisfaction indicators, preference patterns, or behavioral cues that reflect the first entity's response to previously rendered digital artifacts and the effectiveness of current visualization interface configurations. The visualization agent 208 is further configured to re-generate the first set of weights for the first subset of digital artifacts based on the set of user feedback by applying computational algorithms that incorporate feedback signals to adjust, modify, or recalculate the weight values assigned to each digital artifact within the first subset of digital artifacts, ensuring that the updated weights reflect the first entity's demonstrated preferences, changing operational priorities, or evolving task requirements as indicated by the set of user feedback. The visualization agent 208 is further configured to select at least a fourth digital artifact of the first subset of digital artifacts based on the re-generated first set of weights by evaluating the updated weight values to identify digital artifacts that exhibit the highest priority, relevance, or contextual significance according to the adjusted prioritization. The fourth digital artifact represents a digital artifact that may not have been previously selected but now meets the selection criteria based on the updated weight calculations. The visualization agent 208 is further configured to render, via the visualization interface 130 of the user device 116 associated with the first entity, at least the fourth digital artifact along with any associated metadata, contextual information, or related digital artifacts to provide the first entity with an updated and contextually appropriate visualization that reflects their current operational needs and demonstrated preferences as determined through the feedback analysis and weight re-generation process.

The processing circuitry 104 is further configured to update the first subset of logic constraints stored in the logic store 112 based on the set of user feedback generated by the visualization agent 208. The first subset of logic constraints pertains specifically to the priority determination and weight generation processes associated with the first subset of digital artifacts for the first entity. The processing circuitry 104 may modify, adjust, or reconfigure the computational rules, predefined weight values, priority hierarchies, and decision-making protocols within the first subset of logic constraints to reflect insights derived from the set of user feedback regarding the first entity's demonstrated preferences, changing operational requirements, or evolving task priorities. The processing circuitry 104 may implement the logic constraint updates by analyzing the set of user feedback to identify patterns indicating satisfaction or dissatisfaction with previously rendered digital artifacts, determining which priority rules or weight assignments contributed to suboptimal visualization outcomes, and systematically adjusting the corresponding logic constraints to improve future digital artifact selection and prioritization processes for the first entity. The updated first subset of logic constraints may include revised priority rankings for different categories of digital artifacts, modified weight calculation parameters that better align with the first entity's operational workflow, adjusted threshold values for artifact selection criteria, or enhanced conditional logic that accounts for temporal factors and contextual significance as indicated by the first entity's feedback patterns, thereby ensuring that subsequent weight generation and digital artifact selection processes performed by the processing circuitry 104 produce visualization interfaces that are increasingly aligned with the first entity's operational needs and demonstrated preferences.

In some embodiments, the visualization agent 208 may be configured to dynamically present, to the first entity (for example, a developer) associated with the computing system 114, prioritized, context-aware visualizations of the set of belief states for the set of belief types associated with each digital artifact of the set of digital artifacts 120 via the visualization interface 130.

In some embodiments, the processing circuitry 104 utilizes the belief state update agent 206, which is an AI-based system employing artificial intelligence algorithms to maintain and modify the probabilistic representations of states of digital artifacts and digital artifact relationships. The belief state update agent 206 may be implemented as an agentic AI-based system that operates autonomously to update the set of belief spaces 216 based on new evidence, events, and user interactions. The belief state update agent 206 may possess goal-directed behavior focused on maintaining accurate and current belief representations. The belief state update agent 206 may be configured to have decision-making capabilities to determine which belief states in the set of belief spaces 216 require updates. The belief state update agent 206 may update the belief states based on incoming information and adaptive learning mechanisms to refine belief state accuracy over time through continuous evidence integration. In some embodiments, the belief state update agent 206 may be configured to update one or more belief states associated with one or more belief types of a digital artifact, of the set of digital artifacts 120, which may be affected by occurrence of an event. The belief state update agent 206 may update the belief states using reasoning algorithms, knowledge graphs, and Bayesian inference.

The processing circuitry 104 may further utilize the probability and confidence scoring agent 212 that may be an AI-based system employing artificial intelligence algorithms to calculate and assign numerical probability values and confidence metrics to belief states associated with belief types of a digital artifact of the set of digital artifacts 120. The probability and confidence scoring agent 212 may be implemented as agentic AI-based systems that may operate autonomously to evaluate likelihood and reliability of various system states, artifact associations, and user preferences. The probability and confidence scoring agent 212 may possess goal-directed behavior focused on providing accurate quantitative assessments of uncertainty and reliability. The probability and confidence scoring agent 212 may have decision-making capabilities to determine appropriate scoring methodologies based on available evidence and historical data. The probability and confidence scoring agent 212 may have adaptive learning mechanisms to continuously improve scoring accuracy through validation against actual outcomes and user feedback. The probability and confidence scoring agent 212 may be configured to calculate and update probability and confidence scores for a set of belief states (for example, the first subset of belief states) using advanced probabilistic modelling (e.g., Monte Carlo simulations, Bayesian inference). Further, the probability and confidence scoring agent 212 may enable sophisticated scoring that may enable the processing circuitry 104 to prioritize operations associated with the highest expected impact, optimizing resource usage and reducing wasted computation on low-impact areas. That is to say, the sophisticated scoring approach may lead to efficient execution of the set of operations associated with the event. The probability and confidence scoring agent 212 further sends the probability or confidence scores to the belief state update agent 206 to update corresponding belief states.

The reinforcement learning agent 210 may be an AI-based agent that employs artificial intelligence algorithms to optimize system behavior through reward-based learning mechanisms. The reinforcement learning agent 210 may be implemented as an agentic AI-based component that operates autonomously to analyze user feedback signals, evaluate system performance outcomes, and modify logic constraints to improve future responses. The reinforcement learning agent 210 may possess goal-directed behavior focused on maximizing user satisfaction and system effectiveness. The reinforcement learning agent 210 may have decision-making capabilities to determine which logic constraint weights should be adjusted based on positive or negative feedback received from the user interaction agent 202. The reinforcement learning agent 210 may implement adaptive learning mechanisms to continuously refine optimization strategies through trial-and-error learning processes. Positive interaction patterns, indicated by behaviors such as extended content exploration or increased system interaction, reinforce effective system behaviors through weight adjustments.

The reinforcement learning agent 210 may be further configured to optimize the adaptive visualization of digital artifacts by way of iterative learning mechanisms. The reinforcement learning agent 210 may process explicit and implicit user responses derived from user interactions that may be captured by the user interaction agent 202. Based on the user response, the reinforcement learning agent 210 may update logic constraints stored in the logic store 112. Updated logic constraints may influence visualization strategies, event responses, and prioritization of belief states associated with the set of digital artifacts 120.

In some embodiments, when the visualization of a subset of digital artifacts as a query response results in faster resolution of a user query or issue or improved entity satisfaction, the reinforcement learning agent 210 may assign positive adjustments to corresponding logic constraints associated with the subset of digital artifacts. In some embodiments, inefficient or conflicting outcomes from the visualization of the subset of digital artifacts may result in negative adjustments to the corresponding logic constraints associated with the subset of digital artifacts. Over time, the reinforcement learning agent 210 may autonomously refine the performance of the adaptive visualization system 102 by balancing exploration of new strategies (stored in the short-term memory) with exploitation of previously effective strategies (stored in the long-term memory). Adaptive learning capability may enable continuous improvement in accuracy, responsiveness, and computational efficiency. The reinforcement learning agent 210 may ensure that the visualization of the subset of digital artifacts evolves with changing usage patterns of entities, digital artifact dependencies, and operational contexts of entities.

In some embodiments, the reinforcement learning agent 210 is configured to access the first set of user actions stored in the short-term memory. The reinforcement learning agent 210 is further configured to determine a set of feedback based on the first set of user actions by analyzing the interactive behaviors, engagement patterns, and navigation sequences exhibited by the first entity to derive implicit feedback signals that indicate satisfaction or dissatisfaction with the current visualization interface configuration. The reinforcement learning agent 210 may interpret user actions such as repeated query reformulations, extended dwell times on specific digital artifacts, rapid navigation away from rendered content, or frequent return visits to particular artifacts as indicators of positive or negative feedback regarding the relevance and effectiveness of the presented digital artifacts. The set of feedback may include quantitative measures such as engagement scores, satisfaction indicators, or preference ratings that the reinforcement learning agent 210 generates by evaluating the temporal patterns, interaction frequencies, and behavioral consistency within the first set of user actions, enabling the system 102 to continuously improve digital artifact selection and prioritization processes based on the first entity's demonstrated preferences and operational requirements. T he reinforcement learning agent 210 is further configured to update the first subset of logic constraints associated with the set of digital artifacts based on the set of feedback, as described throughout the description.

The dependency analysis agent 214 may be configured to generate a dependency graph that may depict associations (for example, semantic associations and syntactic associations) among two or more digital artifacts of the set of digital artifacts 120. The dependency analysis agent 214 may determine dependency relationships between the set of digital artifacts 120 based on the first set of role attributes or knowledge graphs associated with the set of digital artifacts 120. The dependency analysis agent 214 may enable the processing circuitry 104 to identify the semantic associations or the syntactic associations between digital artifacts for enhanced and optimal visualization thereof.

The dependency analysis agent 214 may be an AI-based system that employs artificial intelligence algorithms to analyze, map, and maintain complex interdependencies between digital artifacts within the software ecosystem. The dependency analysis agent 214 may be implemented as an agentic AI-based component that may operate autonomously to discover both direct and indirect relationships between digital artifacts, trace impact propagation paths, and update the dependency graph to reflect the relationships between digital artifacts and impact propagation among the digital artifacts. The dependency analysis agent 214 may possess goal-directed behavior focused on maintaining comprehensive and accurate dependency mappings by way of the dependency graph. The dependency analysis agent 214 may use decision-making capabilities to determine the significance and type of associations between the digital artifacts (semantic or syntactic associations). The dependency analysis agent 214 may use adaptive learning mechanisms to continuously refine dependency detection accuracy through analysis of user behavior patterns and user interactions. The event processing agent 204 may detect events associated with digital artifacts and trigger a selection of related artifacts, which the visualization agent 208 renders in association with the originally selected artifacts.

The dependency analysis agent 214 may determine dependency relationships between the set of digital artifacts 120 based on role attributes or dependency graphs. The dependency analysis agent 214 may identify semantic associations or syntactic associations between the set of digital artifacts for enhanced visualization interface processing. The event processing agent 204 may detect events associated with the set of digital artifacts and trigger the selection of related digital artifacts, which the visualization agent 208 may render in association with originally selected artifacts. In some embodiments, the processing circuitry 104 may be further configured to utilize the dependency analysis agent 214 to determine the association between the first digital artifact and the fourth digital artifact. The dependency analysis agent 214 is configured to determine the association (for example, the semantic association or the syntactic association) between the first digital artifact and the fourth digital artifact based on at least one of: the first set of role attributes or the dependency graph associated with the set of digital artifacts 120. The application of the first set of role attributes or the dependency graph may ensure optimal turnaround time for data retrieval, optimized execution paths, and lower computational overhead.

In some embodiments, the processing circuitry 104 may be further configured to train one or more agents of the set of agents 110 based on corresponding training data. The training may be performed for a training time interval. The training of each of the set of agents 110 may be performed based on one or more training algorithms (for example, few-shot learning, supervised learning, unsupervised learning, or the like) known in the art. The processing circuitry 104 may be further configured to store the set of agents in the storage element 106. The processing circuitry 104 may be further configured to access the set of agents 110 from the storage element 106. Operations executed by the event processing agent 204, the belief state update agent 206, the visualization agent 208, the probability and confidence scoring agent 212, and the dependency analysis agent 214 may actually be executed by the processing circuitry 104 by utilizing the set of agents 110.

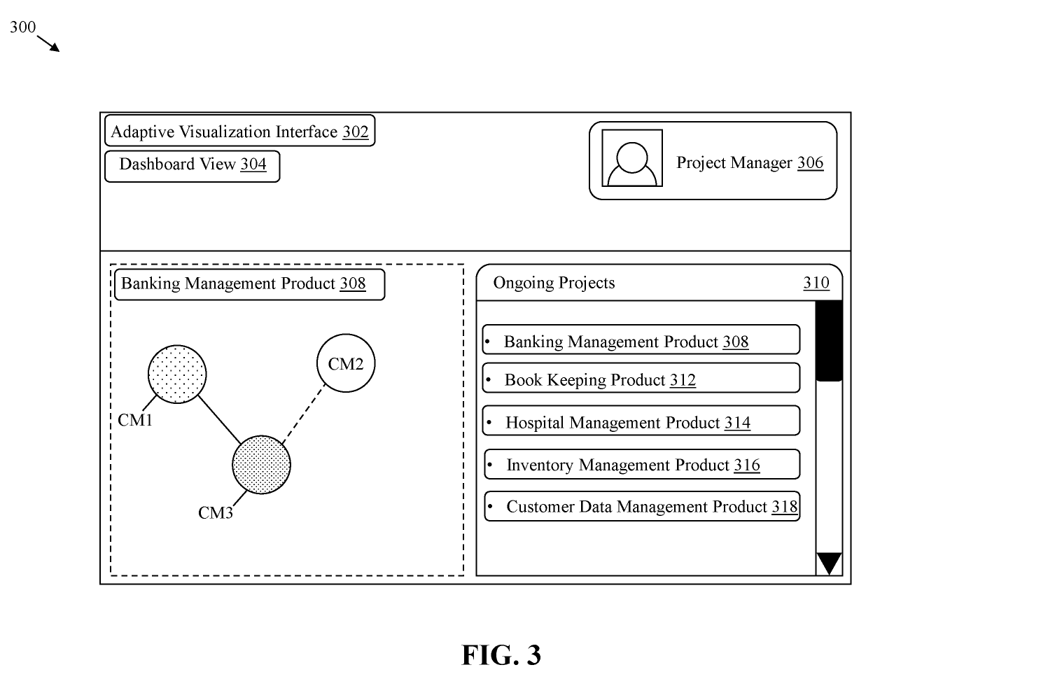

FIG. 3 illustrates a schematic diagram 300 depicting an exemplary interface of the user application associated with the adaptive visualization system 102, consistent with disclosed embodiments of the present disclosure. The exemplary interface corresponds to an adaptive visualization interface 302, which serves as the primary user interface for displaying digital artifacts and their relationships, shown at a given instance in time. The adaptive visualization interface 302, which presents a dashboard view 304, is a comprehensive overview panel that provides user-specific visualizations and system information. The interface 300 includes an option to select or display a user role, as demonstrated by a project manager 306, which represents a specific user entity with defined role attributes accessing the adaptive visualization interface 302.

The adaptive visualization interface 302 displays a visualization corresponding to a banking management product 308, which represents a software project or application domain containing multiple related digital artifacts. The adaptive visualization interface 302 presents multiple code modules associated with the banking management product 308. The presented code modules are shown to include a code module CM1 (represented by a circle CM1), which is a first code module or digital artifact within the banking management product 308, another code module CM2 (represented by a circle CM2), which is a second code module or digital artifact within the banking management product 308, and CM3 (represented by a circle CM2), which is a third code module or digital artifact within the banking management product 308. These code modules CM1, CM2, and CM3 demonstrate inter-module relationships through connecting lines, where a solid line connecting the code modules CM1 and CM3 indicates strong relevance or direct dependencies therebetween, while dotted lines show weaker or indirect associations, such as between the code modules CM2 and CM3. Further, to indicate relevance or priority of the code modules CM1, CM2, and CM3, a first node depicting the code module CM3 is densely populated with dots indicating a high relevance or priority, a second node depicting the code module CM3 is scarcely populated with dots indicating a moderate relevance or priority, and a third node depicting the code module CM2 which is not populated with dots to indicate its relevance or priority being least among the code modules CM1, CM2, and CM3.

The adaptive visualization interface 302 further provides access to other ongoing projects via a section 310 of the adaptive visualization interface 302, which represents a collection of additional software projects or application domains available to the user. These include a bookkeeping product 312, which is a financial management software project, a hospital management product 314, which is a healthcare management software project, an inventory management product 316, which is a supply chain management software project, and a customer data management product 318, which is a customer relationship management software project. The project manager 306 can select and visualize different products based on current assignments, while the adaptive visualization system 102 dynamically determines and displays the most relevant set of digital artifacts or code modules based on the user's role attributes and interaction patterns.

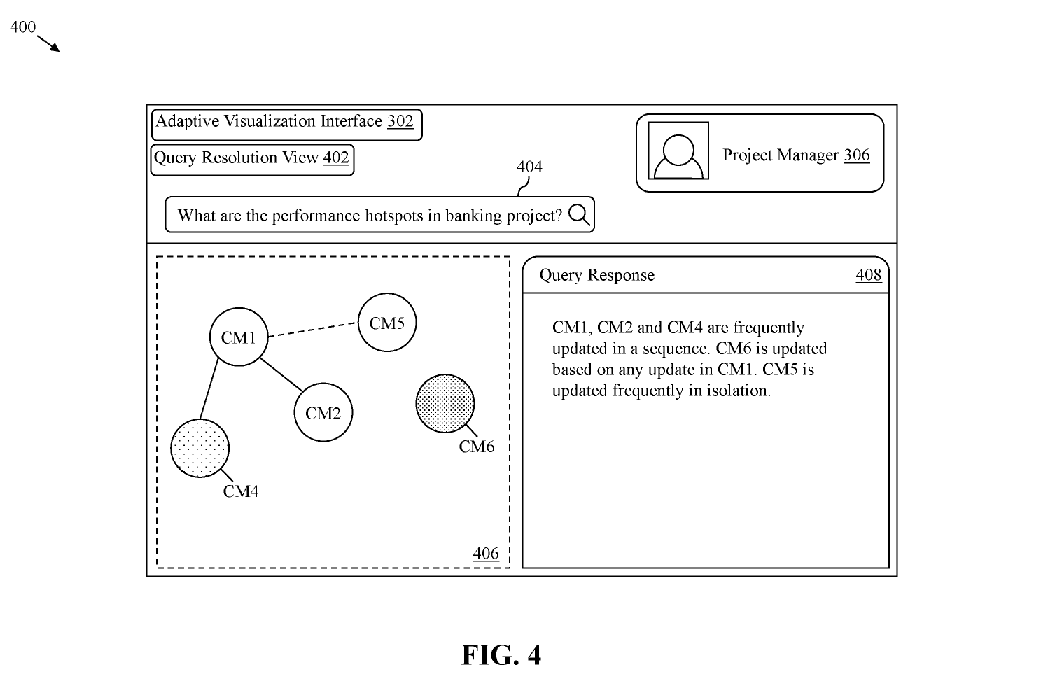

FIG. 4 illustrates a schematic diagram 400 of another exemplary interface of the user application associated with the adaptive visualization system 102, consistent with disclosed embodiments of the present disclosure. FIG. 4 depicts a query resolution view 402, which is an interactive interface component of the adaptive visualization interface 302 that enables query processing functionality in conjunction with adaptive visualization capabilities. The query resolution view 402 includes a query input field 404, which is a user interface element that allows users to enter natural language or structured queries, a visualization segment 406, which is a display area configured to render dynamic visual representations of digital artifacts and their relationships, and a query response section 408, which is a display component configured to present detailed textual responses corresponding to user queries. The query input field 404 allows users to enter natural language or structured queries associated with ongoing projects depicted in FIG. 3, such as requests for identifying code dependencies, module performance insights, or defect correlations.

For example, the user may provide a user query, ‘What are the performance hotspots in banking project?’ by way of the query input field 404. Upon receiving the user query, the adaptive visualization system 102 may process input through its underlying reasoning pipeline, which is a computational framework that includes accessing belief spaces, belief types, and corresponding weights and confidence scores. The adaptive visualization system 102 may compare the received query against belief spaces, belief types, and weights to identify most contextually relevant subset of digital artifacts. Based on computed relevance/priority scores, which are numerical values indicating the degree of contextual significance of each digital artifact relative to the user query, the visualization agent 208 may generate a weighted arrangement of the subset of digital artifacts and may render a dynamic visualization within the visualization segment 406 based on the weighted arrangement, highlighting associated digital artifacts (for example, code modules) and interconnections or dependencies between the code modules. Different code modules may be represented using distinct colors, line styles, or node thicknesses to indicate varying levels of relevance, confidence, or dependency strength as described in conjunction with FIG. 3.

The query response section 408 may display a detailed query response ‘CM1, CM2 and CM4 (represented by a circle CM4) are frequently updated in a sequence. CM5 (represented by a circle CM5) is updated based on any update in CM1. CM6 (represented by a circle CM6) is updated frequently in isolation.’ corresponding to the user's query, which may include explanatory text, prioritized results, or ranked suggestions derived through AHP and retrieval-augmented generation (RAG) techniques. AHP, as referenced herein, refers to Analytic Hierarchy Process, which is a structured decision-making methodology for prioritizing alternatives based on multiple criteria. RAG techniques, as defined herein, refer to retrieval-augmented generation methods that combine information retrieval with generative processing to produce contextually relevant responses. The adaptive visualization system 102 thereby assists the user not only in visualizing relationships among the set of digital artifacts 120 but also in resolving project-specific queries through intelligent, role-aware analysis and context-driven responses.

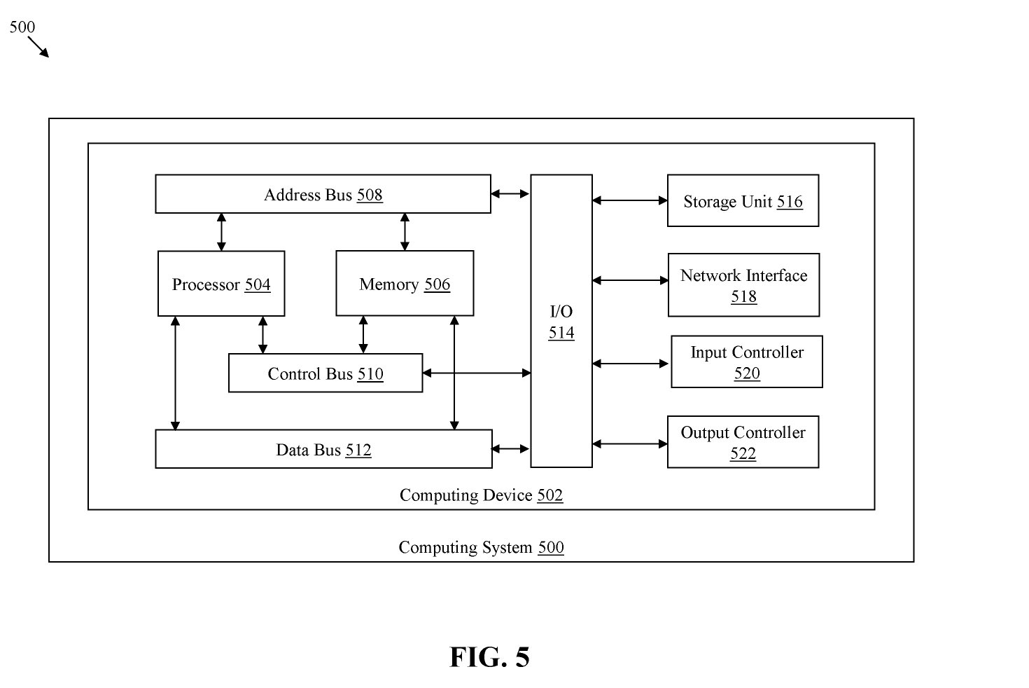

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 may be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art may recognize that the memory 506 may be separate from the computing device 502.

The memory 506 may store information that may be accessed by the processor 504. For instance, the memory 506 (e.g., one or more non-transitory computer-readable storage mediums, memory devices) may include computer-readable instructions (not shown) that may be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that, when executed by the processor 504, cause the processor 504 to perform operations such as any of the operations and functions for which the computing system 500 is configured, as described herein. Additionally, or alternatively, the memory 506 may store data (not shown) that may be obtained, received, accessed, written, manipulated, created, and/or stored. The data may include, for instance, the data and/or information described herein in relation to FIGS. 1 – 4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks, which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions that, when executed by the processor 504, cause the computing system 500 to perform the method steps of the present disclosure. Alternatively, the storage unit 516 is a transitory computer-readable medium. The storage unit 516 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive the digital artifacts. The output controller 522 may include suitable logic, circuitry, interfaces, and/or code, executable by the circuitry, that may be configured to control one or more output devices that may be configured to output probability and confidence scores to manage the belief state.

In some embodiments, a computer-readable medium is disclosed. The computer-readable medium includes instructions that, when executed by a processing circuitry that includes the processor 504 of the computing system 500, cause the computing system 500 to perform a method for adaptive visualization of digital artifacts. The method includes accessing the first set of role attributes corresponding to the first entity associated with the set of digital artifacts 120. The first set of role attributes is indicative of at least one of one or more operational constraints or one or more functional constraints associated with the first entity. The method further includes identifying, based on the first set of role attributes, the first subset of digital artifacts from the set of digital artifacts 120. The first subset of digital artifacts is contextually associated with the first set of role attributes. The method further includes determining the first set of user actions associated with the first entity via the user device 116. The first set of user actions is determined for the predefined time period. The method further includes generating, based on the first set of user actions, the first set of weights for the first subset of digital artifacts. The first set of weights is indicative of a priority associated with the first subset of digital artifacts for the first entity. The method further includes selecting at least the first digital artifact from the first subset of digital artifacts based on the first set of weights. The method further includes rendering via the first visualization interface of the first user device, at least the first digital artifact.

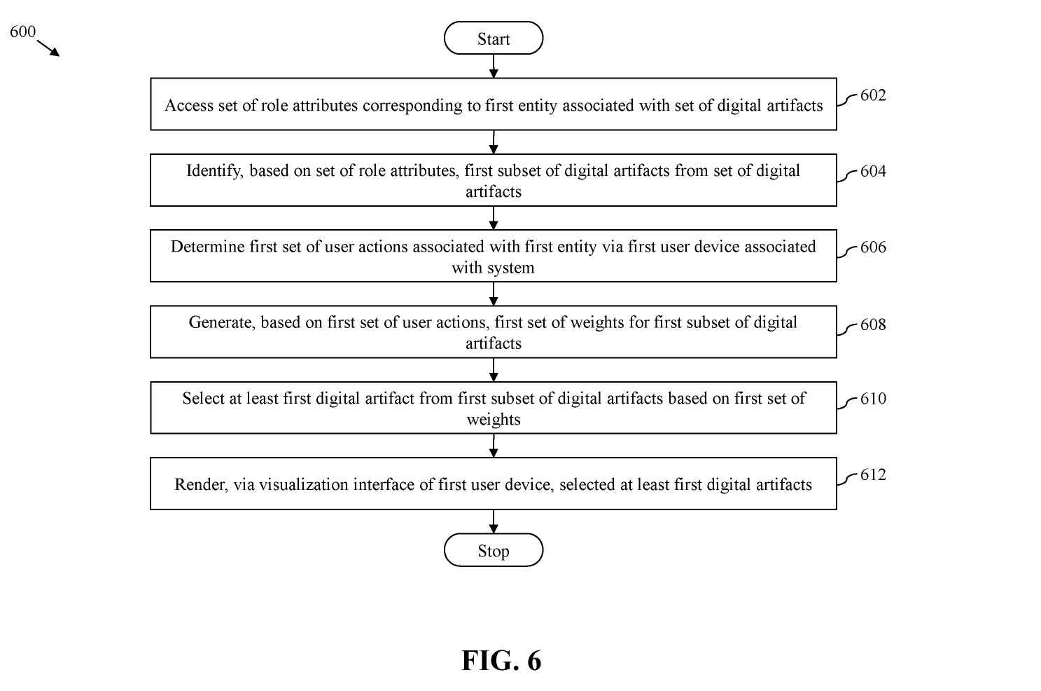

FIG. 6 is a flowchart 600 that illustrates a method for adaptive visualization of digital artifacts, consistent with disclosed embodiments of the present disclosure. Referring to FIG. 6, the method 600 may be implemented by the adaptive visualization system 102 using one or more agents stored in the storage element 106 and executed by the processing circuitry 104. The method may be performed automatically, continuously, or in response to an event or user query received through the visualization interface 130.

At step 602, the first set of role attributes corresponding to the first entity associated with the set of digital artifacts 120 stored in the storage element 106 may be accessed. The processing circuitry 104 may determine the first set of role attributes corresponding to the first entity associated with the set of digital artifacts 120. The set of role attributes is indicative of at least one of the one or more operational constraints or the one or more functional constraints associated with the first entity. The determination of the first set of role attributes may be based on the set of logic constraints stored in the logic store 112 or retrieved dynamically from the stored data sources or historical user interaction patterns.

At step 604, the first subset of digital artifacts may be identified from the set of digital artifacts 120 based on the first set of role attributes. The first subset of digital artifacts is contextually associated with the first set of role attributes. The processing circuitry 104 may identify the first subset of digital artifacts from the set of digital artifacts 120 based on the first set of role attributes.

At step 606, the first set of user actions associated with the first entity may be determined via the user device 116 associated with the adaptive visualization system 102. User actions may include explicit inputs and implicit interaction patterns. The user interaction agent 202 may track and record the user interaction pattern through the visualization interface 130. The processing circuitry 104 may be configured to determine the first set of user actions associated with the first entity via the user device 116.

At step 608, the first set of weights for the first subset of digital artifacts may be generated based on the first set of user actions. The first set of weights is indicative of the priority associated with each of the first subset of digital artifacts for the first entity. The processing circuitry 104 may be configured to generate the first set of weights.

At step 610, at least the first digital artifact may be selected from the first subset of digital artifacts based on the first set of weights. The processing circuitry 104 may be configured to select the first digital artifact from the first subset of digital artifacts.

At step 612, the selected first digital artifact may be rendered via the visualization interface 130 of the user device 116. The processing circuitry 104 is configured to render the selected first digital artifact via the visualization interface 130 of the user device 116.

For the sake of brevity, the ongoing description is described with respect to the first entity associated with the user device 116. In other embodiments, adaptive visualization of digital artifacts for one or more entities associated with other entity devices may be performed as described throughout the description.

The system disclosed herein provides significant technical improvements over conventional visualization systems. The adaptive visualization system disclosed herein dynamically selects and renders digital artifacts based on user actions and role attributes and significantly eliminates the static, one-size-fits-all approach of conventional code visualization systems, resulting in more relevant and contextually appropriate visual presentations that reduce information overload and improve developer productivity.

The dynamic weight generation and prioritization mechanism enables the visualization interface to automatically highlight the most critical code components based on real-time analysis of user behavior patterns, providing substantial improvements over manual filtering systems by ensuring that developers consistently see the most relevant artifacts without requiring explicit configuration or search operations. This automated prioritization reduces the time required to locate critical code elements and minimizes the risk of overlooking important system components during code analysis tasks.

The reinforcement learning-based feedback mechanism that updates visualization weights based on user sentiment provides measurable improvements in interface effectiveness over time, automatically adapting the visual presentation to match organizational workflows and individual developer preferences without manual reconfiguration. This adaptive capability ensures that the visualization interface becomes increasingly aligned with user needs, resulting in improved user satisfaction and reduced training requirements.

The context-aware digital artifact selection and rendering process based on user queries enables more precise and relevant visualization responses compared to keyword-based search systems, providing developers with exactly the code components and documentation needed for their current tasks. The weighted arrangement of digital artifacts ensures that the most important elements are prominently displayed, reducing visual clutter and enabling faster identification of critical system components during code modernization activities.

The logic constraint-based weight generation system provides enhanced consistency and accuracy in digital artifact prioritization compared to ad-hoc ranking methods, ensuring that visualization decisions align with organizational policies and technical requirements. The ability to update logic constraints based on user feedback creates a self-improving visualization system that becomes more effective over time while maintaining compliance with established operational guidelines.

The implementation of Analytic Hierarchy Process (AHP) and Retrieval-Augmented Generation (RAG) provides enhanced prioritization accuracy compared to conventional ranking systems, enabling more precise identification of critical code components and reducing false positive rates in vulnerability detection and performance bottleneck identification. The event-driven belief state update mechanism ensures that system knowledge remains current without requiring batch processing operations, significantly improving the timeliness of security threat detection and code quality assessments in production environments.

A person of ordinary skill in the art may appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process; however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for AI-based adaptive visualization of digital artifacts. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
a storage element configured to store a set of digital artifacts; and
processing circuitry coupled to the storage element, wherein the processing circuitry is configured to:
access a first set of role attributes corresponding to a first entity associated with the set of digital artifacts, wherein the first set of role attributes is indicative of at least one of: one or more operational constraints or one or more functional constraints associated with the first entity;
identify, based on the first set of role attributes, a first subset of digital artifacts from the set of digital artifacts, wherein the first subset of digital artifacts is contextually associated with the first set of role attributes;
determine a first set of user actions associated with the first entity via a first user device associated with the system;
generate, based on the first set of user actions, a first set of weights for the first subset of digital artifacts, wherein the first set of weights is indicative of a priority associated with each of the first subset of digital artifacts for the first entity;
select at least a first digital artifact from the first subset of digital artifacts based on the first set of weights; and
render, via a first visualization interface of the first user device, at least the first digital artifact.

2. The system of claim 1, wherein the processing circuitry is further configured to:
select a second digital artifact from the first subset of digital artifacts based on the first set of weights; and
render, via the first visualization interface of the first user device, the selected second digital artifact.

3. The system of claim 1, wherein the first set of user actions is determined for a predefined time interval.

4. The system of claim 3, wherein the processing circuitry is further configured to:
determine a second set of role attributes corresponding to a second entity associated with the set of digital artifacts, wherein the second set of role attributes is indicative of at least one of one or more operational constraints or one or more functional constraints associated with the second entity;
identify, based on the second set of role attributes, a second subset of digital artifacts from the set of digital artifacts, wherein the second subset of digital artifacts is contextually associated with the second set of role attributes;
determine a second set of user actions associated with the second entity via a second user device associated with the system, wherein the second set of user actions is determined for the predefined time interval;
generate, based on the second set of user actions, a second set of weights for the second subset of digital artifacts, wherein the second set of weights is indicative of a priority associated with each of the second subset of digital artifacts for the second entity;
select at least a third digital artifact from the second subset of digital artifacts based on the second set of weights; and
render, via a second visualization interface of the second user device, at least the third digital artifact.

5. The system of claim 1,
wherein the storage element is further configured to store a set of belief spaces associated with the set of digital artifacts,
wherein a belief space of the set of belief spaces includes a set of belief types associated with a corresponding digital artifact of the set of digital artifacts, and
wherein the processing circuitry is further configured to:
identify, based on at least the first digital artifact, a first belief space of the set of belief spaces associated with at least the first digital artifact;
determine, based on the first set of user actions, a subset of belief types from a first set of belief types associated with the first belief space; and
render, via the first visualization interface, the subset of belief types and a set of belief states associated with the subset of belief types.

6. The system of claim 1, wherein the storage element is further configured to store at least one of: a user interaction agent, an event processing agent, a visualization agent, a reinforcement learning agent, or a dependency analysis agent.

7. The system of claim 6, wherein the processing circuitry is further configured to utilize the user interaction agent for the determination of the first set of user actions, and wherein to determine the first set of user actions, the user interaction agent is configured to:
monitor the first visualization interface of the first user device; and
record, based on the monitoring, the first set of user actions via the first visualization interface of the first user device.

8. The system of claim 7, wherein the processing circuitry is further configured to utilize the visualization agent for the selection of at least the first digital artifact, and wherein the visualization agent is configured to:
receive the first set of user actions from the user interaction agent;
determine a set of prioritization criteria associated with the first entity based on at least one of: the first set of role attributes or the first set of user actions, wherein the set of prioritization criteria is indicative of the priority associated with the first subset of digital artifacts for the first entity; and
generate the first set of weights based on the set of prioritization criteria.

9. The system of claim 8, wherein the set of prioritization criteria is determined further based on an analytic hierarchy process (AHP).

10. The system of claim 6, wherein the visualization agent is configured to:
determine a context associated with the first set of user actions;
generate, based on the context, a set of user feedback associated with the first entity;
re-generate the first set of weights for the first subset of digital artifacts based on the set of user feedback;
select at least a fourth digital artifact of the first subset of digital artifacts based on the re-generated first set of weights; and
render, via the first visualization interface of the first user device, at least the fourth digital artifact.

11. The system of claim 10,
wherein the storage element is further configured to store a set of logic constraints that includes a subset of logic constraints that pertains to the priority associated with the first subset of digital artifacts for the first entity, and
wherein the processing circuitry is further configured to update the subset of logic constraints based on the set of user feedback.

12. The system of claim 6,
wherein the processing circuitry is further configured to utilize the visualization agent for the selection of at least the first digital artifact,
wherein the storage element is further configured to store a set of logic constraints that includes a first subset of logic constraints that pertains to the priority associated with the first subset of digital artifacts for the first entity, and
wherein the visualization agent is configured to:
generate the first set of weights based on the first subset of logic constraints of the set of logic constraints; and
identify at least the first digital artifact from the first subset of digital artifacts based on the first set of weights.

13. The system of claim 6, wherein the processing circuitry is further configured to utilize the event processing agent to:
detect a first event associated with at least the first digital artifact, wherein at least the first digital artifact is associated with at least a fourth digital artifact of the first subset of digital artifacts; and
select at least the fourth digital artifact based on the detection of the first event, wherein the visualization agent is configured to render, based on the first event, at least the first digital artifact in association with at least the fourth digital artifact via the first visualization interface.

14. The system of claim 13,
wherein the processing circuitry is further configured to utilize the dependency analysis agent to determine the association between at least the first digital artifact and at least the fourth digital artifact, and
wherein the dependency analysis agent is configured to determine the association between at least the first digital artifact and at least the fourth digital artifact based on at least one of: the first set of role attributes or a dependency graph associated with the set of digital artifacts.

15. The system of claim 14, wherein the association between at least the first digital artifact and at least the fourth digital artifact is one of: a semantic association or a syntactic association.

16. The system of claim 6, wherein the storage element comprises at least one of: a long-term memory or a short-term memory, and wherein the processing circuitry is further configured to:
retrieve the first set of role attributes corresponding to the first entity associated with the set of digital artifacts from the long-term memory; and
store the first set of user actions in the short-term memory, wherein the reinforcement learning agent is configured to:
access the first set of user actions stored in the short-term memory;
determine a set of feedback based on the first set of user actions; and
update a set of logic constraints associated with the set of digital artifacts based on the set of feedback.

17. The system of claim 1, wherein the processing circuitry is further configured to:
receive a user query via the first visualization interface of the first user device associated with the first entity;
determine a context of the user query based on a set of tokens associated with the user query;
identify a third subset of digital artifacts of the set of digital artifacts based on at least one of: the context of the user query or the first set of role attributes;
generate a weighted arrangement of the third subset of digital artifacts based on a second subset of logic constraints of a set of logic constraints stored in the storage element, wherein the second subset of logic constraints pertains to the priority associated with the first subset of digital artifacts for the first entity; and
render, via the first visualization interface of the first user device, one or more digital artifacts of the third subset of digital artifacts based on the weighted arrangement of the third subset of digital artifacts, wherein the one or more digital artifacts are rendered in response to the user query.

18. A computer-implemented method, comprising:
accessing, a first set of role attributes corresponding to a first entity associated with a set of digital artifacts stored in a storage element, wherein the first set of role attributes is indicative of at least one of one or more operational constraints or one or more functional constraints associated with the first entity;
identifying, based on the first set of role attributes, a first subset of digital artifacts from the set of digital artifacts, wherein the first subset of digital artifacts is contextually associated with the first set of role attributes;
determining a first set of user actions associated with the first entity via a first user device;
generating, based on the first set of user actions, a first set of weights for the first subset of digital artifacts, wherein the first set of weights is indicative of a priority associated with each of the first subset of digital artifacts for the first entity;
selecting at least a first digital artifact from the first subset of digital artifacts based on the first set of weights; and
rendering, via a first visualization interface of the first user device, at least the first digital artifact.

19. The computer-implemented method of claim 18, further comprising:
determining a second set of role attributes corresponding to a second entity associated with the set of digital artifacts, wherein the second set of role attributes is indicative of at least one of: one or more operational constraints or one or more functional constraints associated with the second entity;
identifying, based on the second set of role attributes, a second subset of digital artifacts from the set of digital artifacts, wherein the second subset of digital artifacts is contextually associated with the second set of role attributes;
determining a second set of user actions associated with the second entity via a second user device, wherein at least one of the first set of user actions or the second set of user actions is determined for a predefined time interval;
generating, based on the second set of user actions, a second set of weights for the second subset of digital artifacts, wherein the second set of weights is indicative of a priority associated with each of the second subset of digital artifacts for the second entity;
selecting at least a third digital artifact from the second subset of digital artifacts based on the second set of weights; and
rendering, via a second visualization interface of the second user device, at least the third digital artifact.

20. A non-transitory computer-readable medium comprising instructions that, when executed by processing circuitry of a computing system, cause the computing system to perform a method for adaptive visualization of a set of digital artifacts, the method comprising:
accessing a first set of role attributes corresponding to a first entity associated with the set of digital artifacts stored in a storage element, wherein the first set of role attributes is indicative of at least one of: one or more operational constraints or one or more functional constraints associated with the first entity;
identifying, based on the first set of role attributes, a first subset of digital artifacts from the set of digital artifacts, wherein the first subset of digital artifacts is contextually associated with the first set of role attributes;
determining a first set of user actions associated with the first entity via a first user device;
generating, based on the first set of user actions, a first set of weights for the first subset of digital artifacts, wherein the first set of weights is indicative of a priority associated with each of the first subset of digital artifacts for the first entity;
selecting at least a first digital artifact from the first subset of digital artifacts based on the first set of weights; and
rendering, via a first visualization interface of the first user device, at least the first digital artifact.
